(19) United States
(12) Patent Application Publication
(10) Pub. No.: US 2025/0217025 A1
(43) Pub. Date: Jul. 3, 2025

(54) VIRTUAL SOCIAL SCENE DISPLAY METHOD AND APPARATUS, TERMINAL, AND STORAGE MEDIUM

(71) Applicant: Tencent Technology (Shenzhen) Company Limited, Shenzhen (CN)

(72) Inventor: Teng CHEN, Shenzhen (CN)

(21) Appl. No.: 19/084,608

(22) Filed: Mar. 19, 2025

Related U.S. Application Data
(63) Continuation of application No. PCT/CN2024/070349, filed on Jan. 3, 2024.

(30) Foreign Application Priority Data
Mar. 24, 2023 (CN) 202310351348.4

(51) Int. Cl. G06F 3/04847; G06F 3/0481; H04L 9/40; H04L 51/216

(52) U.S. Cl. CPC G06F 3/04847; G06F 3/0481; H04L 51/216; H04L 63/104

(57) ABSTRACT

Embodiments of this application provide a virtual social scene display method performed by a terminal. The method includes: displaying a virtual social scene in which a plurality of virtual objects corresponding to different social accounts perform social interactions; displaying a permission setting control in a chat interface when at least two virtual objects belong to a same chat group and the chat group is in a public state, a distance between the virtual objects in the chat group being less than a distance threshold; and setting the chat group to a private chat state in response to a trigger operation on the permission setting control. According to the solution provided in the embodiments of this application, chat group setting in the virtual social scene is optimized, and social types in the virtual social scene are enriched.

### CROSS-REFERENCE TO RELATED APPLICATIONS

This application is a continuation application of PCT Patent Application No. PCT/CN2024/070349, entitled “VIRTUAL SOCIAL SCENE DISPLAY METHOD AND APPARATUS, TERMINAL, AND STORAGE MEDIUM” filed on Jan. 3, 2024, which claims priority to Chinese Patent Application No. 202310351348.4, entitled “VIRTUAL SOCIAL SCENE DISPLAY METHOD AND APPARATUS, TERMINAL, AND STORAGE MEDIUM” filed with the China National Intellectual Property Administration on Mar. 24, 2023, all of which are incorporated herein by reference in their entirety.

### FIELD OF THE TECHNOLOGY

Embodiments of this application relate to the field of human-computer interaction technologies, and in particular, to a virtual social scene display method and apparatus, a terminal, and a storage medium.

### BACKGROUND OF THE DISCLOSURE

During virtual social intercourse, a user may perform a voice chat or a text chat with another person by using a virtual character.

In the related art, in a social scene with a plurality of virtual characters, the virtual characters are controlled to move in the virtual social scene, so that a chat may be automatically started between social accounts corresponding to virtual characters that are close to each other. In addition, because the virtual social scene is public, a social account corresponding to another virtual character may also join or exit a chat at any time.

### SUMMARY

Embodiments of this application provide a virtual social scene display method and apparatus, a terminal, and a storage medium, to optimize chat group setting in a virtual social scene, and enrich social types in the virtual social scene. Technical solutions are as follows:

According to an aspect, an embodiment of this application provides a virtual social scene display method performed by a terminal. The method includes:
displaying, by a terminal, a virtual social scene in which a plurality of virtual objects corresponding to different social accounts perform social interactions with one another;
displaying, by the terminal, a permission setting control in a chat interface when at least two virtual objects belong to a same chat group and the chat group is in a public state, a distance between the at least two virtual objects in the chat group being less than a distance threshold; and
setting, by the terminal, the chat group to a private chat state in response to a trigger operation on the permission setting control.

According to another aspect, an embodiment of this application provides a terminal, including a processor and a memory. The memory stores at least one instruction.

The at least one instruction, when executed by the processor, causes the terminal to implement the virtual social scene display method described in the foregoing aspect.

According to another aspect, an embodiment of this application provides a non-transitory computer-readable storage medium, having at least one instruction stored therein. The at least one instruction, when executed by a processor of a terminal, causes the terminal to implement the virtual social scene display method described in the foregoing aspect.

In the embodiments of this application, a virtual social scene in which a virtual object corresponding to a social account performs social interaction is constructed. In the virtual social scene, the social account may control the virtual object to move to make a distance between virtual objects is less than a distance threshold, to create a chat group in a public state between at least two virtual objects whose distance is less than the distance threshold, where the chat group in the public state allows another virtual object to join. A permission setting control is displayed in a chat interface. The permission setting control is used for setting a group joining permission for the chat group. Further, the chat group may be set to a private chat state in response to a trigger operation on the permission setting control, where the chat group in the private chat state does not allow the another virtual object to join. According to the solution provided in the embodiments of this application, a chat permission setting opportunity may be provided in a virtual social scene for a chat group that is in a public state but has a private chat requirement, so that a social account in the chat group may set permission to join the chat group by using the permission setting control, optimizing chat group setting in the virtual social scene, enriching social types in the virtual social scene, and providing privacy protection for social interaction between social accounts corresponding to virtual objects in the chat group.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a schematic diagram of an implementation environment according to an embodiment of this application.

FIG. 2 is a flowchart of a virtual social scene display method according to an exemplary embodiment of this application.

FIG. 3 is a schematic diagram of interface display of a virtual social scene according to an exemplary embodiment of this application.

FIG. 4 is a flowchart of a virtual social scene display method according to another exemplary embodiment of this application.

FIG. 5 is a schematic diagram of an interface of a chat group in a public private chat state according to an exemplary embodiment of this application.

FIG. 6 is a schematic diagram of an interface of a chat group in a secret private chat state according to an exemplary embodiment of this application.

FIG. 7 is a flowchart of a virtual social scene display method according to another exemplary embodiment of this application.

FIG. 8 is a schematic diagram of an interface of entering a public private chat state based on a first voting result according to an exemplary embodiment of this application.

FIG. 9 is a schematic diagram of an interface of entering a secret private chat state based on a first voting result according to an exemplary embodiment of this application.

FIG. 10 is a schematic diagram of an interface of keeping a public state based on a second voting result according to an exemplary embodiment of this application.

FIG. 11 is a schematic diagram of an interface of keeping a public state based on a second voting result according to another exemplary embodiment of this application.

FIG. 12 is a schematic diagram of an interface of controlling a virtual object to exit a chat group according to an exemplary embodiment of this application.

FIG. 13 is a schematic diagram of an interface of controlling a virtual object to exit a chat group according to another exemplary embodiment of this application.

FIG. 14 is a flowchart of a virtual social scene display method according to another exemplary embodiment of this application.

FIG. 15 is a schematic diagram of an interface of entering a public state based on a third voting result according to an exemplary embodiment of this application.

FIG. 16 is a schematic diagram of an interface of keeping a public private chat state based on a fourth voting result according to an exemplary embodiment of this application.

FIG. 17 is a flowchart of a virtual social scene display method according to another exemplary embodiment of this application.

FIG. 18 is a sequence diagram of interaction between a user layer, a presentation layer, and a backend logical layer according to an exemplary embodiment of this application.

FIG. 19 is a block diagram of a structure of a virtual social scene display apparatus according to an exemplary embodiment of this application.

FIG. 20 is a schematic diagram of a structure of a terminal according to an exemplary embodiment of this application.

### DESCRIPTION OF EMBODIMENTS

To make the objectives, technical solutions, and advantages of this application clearer, the following further describes implementations of this application in detail with reference to the accompanying drawings.

In this application, a prompt interface or a pop-up window can be displayed, or voice prompt information can be outputted before related data of a social account and a virtual object corresponding to the social account is collected and when user-related data is collected. The prompt interface, the pop-up window, or the voice prompt information is used for prompting a user that the user-related data is currently being collected. In this way, in this application, related operations of obtaining the user-related data only start to be executed after a confirmation operation of the user on the prompt interface or the pop-up window is obtained. Otherwise (that is, the confirmation operation of the user on the prompt interface or the pop-up window is not obtained), the related operations of obtaining the user-related data are ended, that is, the user-related data is not obtained. In other words, information (including but not limited to user device information, user personal information, other information, and information about a virtual object controlled by a social account corresponding to the user), data (including but not limited to data for analysis, stored data, presented data, and the like), and signals involved in this application are all authorized by the user or fully authorized by various parties, and collection, use, and processing of related data need to comply with relevant laws, regulations, and standards of relevant regions. For example, information about the social account, information about the virtual object controlled by the social account, and the like in this application are all obtained under full authorization.

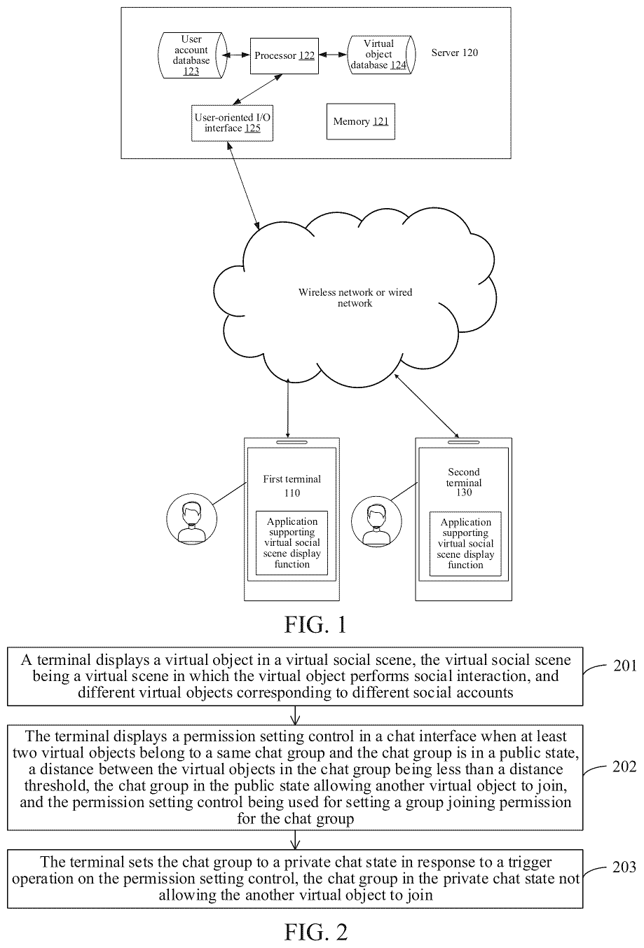

FIG. 1 is a schematic diagram of an implementation environment according to an embodiment of this application. The implementation environment may include a first terminal 110, a server 120, and a second terminal 130.

The first terminal 110 and the second terminal 130 are electronic devices having a virtual social scene display function. The virtual social scene display function may be a functional module in an application having a social attribute, or may be an independent desktop client or web client. For example, the virtual social scene display function is a functional module in an instant messaging application, and is used for a registered user to perform social interaction in a virtual social scene by using a virtual object. The electronic device may be a smartphone, a tablet computer, a personal computer, a wearable device, an in-vehicle terminal, or the like.

In some embodiments, applications installed on the first terminal 110 and the second terminal 130 are the same, or applications installed on the first terminal 110 and the second terminal 130 are a same type of applications on different operating system platforms (Android or iOS). The first terminal 110 may generally be one of a plurality of terminals, and the second terminal 130 may generally be another one of the plurality of terminals. In this embodiment, the first terminal 110 and the second terminal 130 are merely used as examples. Device types of the first terminal 110 and the second terminal 130 are the same or different. The device type includes at least one of a smartphone, a tablet computer, an e-book reader, a moving picture experts group audio layer 3 (MP3) player, a moving picture experts group audio layer 4 (MP4) player, a laptop computer, and a desktop computer.

In FIG. 1, an example in which the first terminal 110 and the second terminal 130 are smartphones and are installed with applications having the virtual social scene display function is used for description, but this is not limited.

FIG. 1 shows only two terminals. However, a plurality of other terminals may access the server 120 in different embodiments. The first terminal 110, the second terminal 130, and the other terminals are connected to the server 120 over a wireless network or a wired network.

The server 120 includes at least one of one server, a server cluster including a plurality of servers, a cloud computing platform, and a virtualization center. The server 120 is configured to provide a backend service for an application supporting the virtual social scene. In some embodiments, the server 120 undertakes primary computing work, and the terminals undertake secondary computing work. Alternatively, the server 120 undertakes secondary computing work, and the terminals undertake primary computing work. Alternatively, a distributed computing architecture is used between the server 120 and the terminals for collaborative computing.

The server 120 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and AI platform.

In a schematic example, the server 120 includes a memory 121, a processor 122, a user account database 123, a virtual object database 124, and a user-oriented input/output interface (I/O interface) 125. The processor 122 is configured to load instructions stored in the server 120 and process data in the user account database 123 and the virtual object database 124. The user account database 123 is configured to store data of user accounts used by the first terminal 110, the second terminal 130, and the other terminals, for example, avatars of the user accounts and nicknames of the user accounts. The virtual object database 124 is configured to store object data of a virtual object created by each user account. The user-oriented I/O interface 125 is configured to establish communication with the first terminal 110 and/or the second terminal 130 over the wireless network or the wired network for data exchange, thereby implementing transmission and reception of social messages between the accounts.

FIG. 2 is a flowchart of a virtual social scene display method according to an exemplary embodiment of this application. This embodiment is described by using an example in which the method is applied to a terminal shown in FIG. 1. The method includes the following operations.

Operation 201: The terminal displays a virtual object in a virtual social scene, the virtual social scene being a virtual scene in which the virtual object performs social interaction, and different virtual objects corresponding to different social accounts.

In some embodiments, the virtual social scene is a virtual scene in which the virtual object performs social interaction, and is a virtual environment displayed (or provided) when a target application is run on the terminal. The virtual environment may be a simulated environment of a real world, a semi-simulated semi-fictional environment, or an entirely fictional environment. The virtual environment may be any one of a two-dimensional virtual environment, a 2.5-dimensional virtual environment, and a three-dimensional virtual environment. This is not limited in this application.

In some embodiments, the virtual social scene may be customized by a user, that is, virtual social scenes displayed during login with different social accounts may be the same or different. For example, a social account “Zhang San” sets the virtual social scene to a virtual park, and a social account “Li Si” sets the virtual social scene to a virtual restaurant.

In this embodiment of this application, one or more virtual objects are displayed in the virtual social scene. The terminal shown in this embodiment of this application is a terminal for login with a social account corresponding to any virtual object. A processing process of another terminal is the same as that in this embodiment of this application, and details are not described herein again.

In some embodiments, a virtual object corresponding to a social account that establishes a social relationship with a social account for login on the terminal or a virtual object corresponding to a social account that does not establish a social relationship with the social account for login on the terminal may be displayed in the virtual social scene. This is not limited in this embodiment of this application.

In some embodiments, the virtual social scene includes a setting interface provided for the virtual object. The virtual object is designed and dressed by using the setting interface. Virtual objects corresponding to different social accounts may have the same or different appearances. In addition, for ease of distinguishing between virtual objects corresponding to various social accounts, the terminal displays, around the virtual object in the virtual social scene, a specific label that can represent the virtual object. The label may include an account name of the social account, or may include another label that can implement distinguishing. This is not limited in this embodiment of this application.

In some embodiments, the virtual object is an object controlled by a social account of the target application, and includes, but is not limited to, a virtual character, a virtual animal, an animation, a cartoon character, or the like. Different virtual objects correspond to different social accounts, so that virtual objects of different social accounts are distinguished.

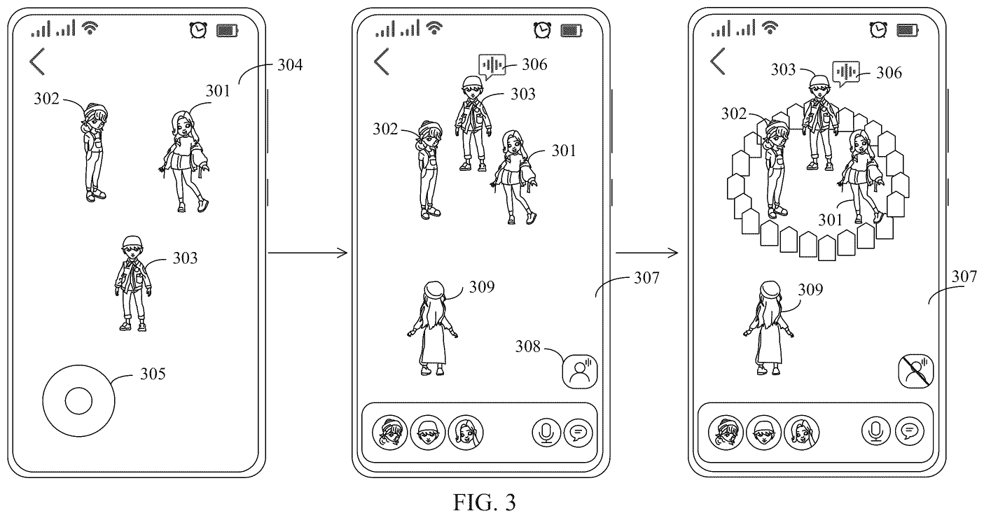

Schematically, as shown in FIG. 3, a first virtual object 301, a second virtual object 302, and a third virtual object 303 are displayed in a virtual social scene 304, and the first virtual object 301, the second virtual object 302, and the third virtual object 303 correspond to different social accounts. Login with a social account corresponding to the first virtual object 301 on the terminal is used as an example. The user may trigger a move control 305 to control the first virtual object 301 to move in the virtual social scene 304. Alternatively, the move control 305 is not displayed, and a slide operation or a tap operation is performed in a display interface of the virtual social scene, to control the first virtual object 301 to move in the virtual social scene 304 in a slide direction or a direction of a tap location.

Operation 202: The terminal displays a permission setting control in a chat interface when at least two virtual objects belong to a same chat group and the chat group is in a public state, a distance between the virtual objects in the chat group being less than a distance threshold, the chat group in the public state allowing another virtual object to join, and the permission setting control being used for setting a group joining permission for the chat group.

In a possible implementation, the terminal for login with each social account may control, by using a move control or performing a slide operation or a tap operation, the virtual object to freely move in the virtual social scene. When the distance between the at least two virtual objects is less than the distance threshold, a chat group is established between the at least two virtual objects, so that social accounts corresponding to the at least two virtual objects may perform social interaction in the virtual social scene by using the chat group, for example, transmit social messages to each other. The social message may include a text message, a picture message, a video message, a website link, a voice message, and the like.

That the distance between the at least two virtual objects is less than the distance threshold means that a distance between any two virtual objects in the at least two virtual objects is less than the distance threshold, or for each virtual object, there is a virtual object in the at least two virtual objects whose distance to the virtual object is less than the distance threshold.

In an exemplary example, the terminal for login with each social account transmits movement information of the virtual object to a server after controlling the virtual object to move, and the server determines location coordinates of the virtual object in the virtual social scene based on the movement information of the virtual object, to determine a distance between virtual objects. The chat group is created between the at least two virtual objects when the server determines that the distance between the at least two virtual objects is less than the distance threshold. Then, a virtual object in a same chat group may transmit a social message. For example, any terminal obtains an input social message, and transmits, based on a social account for login on the terminal, the social message to the server. The server transmits the social message to a social account corresponding to another virtual object in the chat group, and a terminal for login with the social account corresponding to the another virtual object may display the social message.

In some embodiments, when the chat group is created between the at least two virtual objects, the terminal may display an account avatar, an account nickname, and the like of the social account corresponding to the virtual object in the current chat group in the chat interface, or may display a text message input control, a voice message input control, and the like in the chat interface.

In a possible implementation, when the user transmits a social message to another virtual object in a same chat group by using a social account, to enable the social account corresponding to the another virtual object to directly observe a virtual object that is currently speaking, the terminal may display a message prompt control around a virtual object corresponding to the social account that currently transmits the social message. In some embodiments, when the social message is a text message, the message prompt control may directly display text content. When the social message is a voice message, the message prompt control may display a voice play button. When the social message is another message, the message prompt control may display a view button.

In a possible implementation, to make it more convenient for each social account to perform social interaction in the virtual social scene by using a virtual object, when the at least two virtual objects create the chat group, a social account corresponding to another virtual object may also control the virtual object to move to make a distance between the another virtual object and a virtual object in the chat group less than the distance threshold, thereby joining the chat group. In other words, the terminal sets the chat group created by the at least two virtual objects based on the distance to the public state, and the chat group in the public state allows the another virtual object to join. Allowing the another virtual object to join means allowing the another virtual object to automatically join the chat group in a manner of shortening a distance between virtual objects.

In some embodiments, the terminal may obtain location coordinates of the virtual object in the virtual social scene, and determine a distance between any two virtual objects based on location coordinates corresponding to the any two virtual objects.

In a possible implementation, because the chat group in the public state is created based on the distance between the virtual objects, the terminal may control the virtual object of the terminal in the chat group to be far away from another virtual object in the chat group, to control the virtual object to exit the chat group.

In a possible implementation, even in the virtual social scene, social accounts corresponding to virtual objects may have a requirement for a private chat therebetween, that is, when in a same chat group, do not expect a virtual object corresponding to another social account to continue to join the chat group. Therefore, when at least two virtual objects belong to a same chat group, and the chat group is in the public state, the terminal may display a permission setting control in the chat interface. The permission setting control is used for setting a group joining permission for the chat group.

Schematically, as shown in FIG. 3, when a distance between any two of the first virtual object 301, the second virtual object 302, and the third virtual object 303 is less than the distance threshold, the terminal controls the first virtual object 301, the second virtual object 302, and the third virtual object 303 to join a same chat group, and the chat group is in the public state. In addition, distances between a fourth virtual object 309 and the first virtual object 301, the second virtual object 302, and the third virtual object 303 are all greater than the distance threshold. Therefore, the fourth virtual object 309 does not belong to the chat group. However, a social account corresponding to the fourth virtual object 309 may control the fourth virtual object 309 to move to make the distances between the fourth virtual object 309 and the first virtual object 301, the second virtual object 302, and the third virtual object 303 all less than the distance threshold, to control the fourth virtual object 309 to join the chat group.

Login with the social account corresponding to the first virtual object 301 on the terminal is used as an example. When a social account corresponding to the third virtual object 303 transmits a social message, the terminal displays a message prompt control 306 around the third virtual object 303. When the first virtual object 301 belongs to a chat group in the public state, the terminal displays a permission setting control 308 in a chat interface 307.

In a possible implementation, for ease of management in the chat group, a group leader may further be set in the chat group. For example, a virtual object that has been in the chat group for the longest time is set as the group leader, or first two virtual objects joining the chat group are set as group leaders, so that the permission setting control is displayed in a chat interface of the social account corresponding to the group leader. In this case, when the social account for login on the terminal is a social account corresponding to the group leader, the terminal displays the permission setting control in the chat interface. When the social account for login on the terminal is not a social account corresponding to the group leader, the terminal no longer displays the permission setting control in the chat interface.

The group leader of the chat group may be set by the server, or may be set by a terminal corresponding to any virtual object in the chat group.

In a possible implementation, for ease of setting the group joining permission by any virtual object in the chat group, the permission setting control may be displayed in a chat interface of the social account corresponding to each virtual object in the chat group. In this case, the terminal displays the permission setting control in the chat interface.

Operation 203: The terminal sets the chat group to a private chat state in response to a trigger operation on the permission setting control, the chat group in the private chat state not allowing the another virtual object to join.

In a possible implementation, when the permission setting control is displayed in the chat interface of the social account corresponding to the group leader of the chat group, the terminal sets the chat group from the public state to the private chat state in response to the trigger operation on the permission setting control, where the chat group in the private chat state does not allow the another virtual object to join. In addition, not allowing the another virtual object to join means not allowing another virtual object outside the chat group to automatically join the chat group in the manner of shortening the distance between the virtual objects, but it is not limited whether the another virtual object is allowed to join the chat group in another manner. For example, when the chat group is in the private chat state, the another virtual object can join the chat group if a group joining request of the another virtual object for the chat group is agreed by the group leader of the chat group.

In an exemplary example, that the terminal sets the chat group to the private chat state includes: The terminal transmits a state switching request to the server, the state switching request being used for requesting to set the chat group to the private chat state. The server sets the chat group to the private chat state in response to the state switching request. In addition, the server may further transmit a state switching notification to a terminal corresponding to each virtual object in the chat group, so that each terminal determines that the chat group has been switched to the private chat state.

In a possible implementation, when the permission setting control is displayed in a chat interface of the social account corresponding to each virtual object in the chat group, the chat group is set from the public state to the private chat state in response to a trigger operation of a user of one social account on the permission setting control. In an exemplary example, the terminal corresponding to each virtual object in the chat group displays the permission setting control in the chat interface. A user of any terminal performs a trigger operation on the displayed permission setting control. The terminal sets the chat group from the public state to the private chat state in response to the trigger operation, and synchronizes the private chat state of the chat group to a terminal corresponding to another virtual object in the chat group.

Alternatively, the chat group is set from the public state to the private chat state in response to a trigger operation of a user of each social account on the permission setting control. In an exemplary example, the terminal corresponding to each virtual object in the chat group displays the permission setting control in the chat interface. A user of each terminal performs a trigger operation on the displayed permission setting control. A permission setting request is transmitted to the server in response to the trigger operation. The permission setting request is used for requesting to set the chat group to the private chat state. The server records the received permission setting request, and sets the chat group from the public state to the private chat state when it is determined that the terminals corresponding to the virtual objects in the chat group transmit permission setting requests.

Alternatively, a terminal triggering the permission setting control initiates a permission setting request to another social account in response to a trigger operation of a user of one social account on the permission setting control, and when users of all other social accounts agree to the permission setting request, sets the chat group from the public state to the private chat state. In an exemplary example, the terminal corresponding to each virtual object in the chat group displays the permission setting control in the chat interface. A user of any terminal performs a trigger operation on the displayed permission setting control. A permission setting request is transmitted to the server in response to the trigger operation. The permission setting request is used for requesting to set the chat group to the private chat state. The server forwards the permission setting request to a terminal corresponding to another social account in the chat group, and receives a response of each other terminal to the permission setting request. The response is used for indicating to agree to or deny the permission setting request. The server sets the chat group from the public state to the private chat state when determining that each other social account agrees to the permission setting request.

In some embodiments, to prevent the another virtual object outside the chat group from joining the chat group in the private chat state, or remind the another virtual object that the chat group is in the private chat state, when setting the chat group from the public state to the private chat state, the terminal may set a virtual obstacle around the virtual object in the chat group in the virtual social scene, to prompt a social account corresponding to the another virtual object.

In some embodiments, to directly prevent the another virtual object outside the chat group joining the chat group in the private chat state, the terminal may alternatively uniformly transfer the virtual object in the chat group in the private chat state to another scene, thereby preventing the chat group from being seen and joined by the another virtual object in the virtual social scene.

Schematically, as shown in FIG. 3, the first virtual object 301, the second virtual object 302, and the third virtual object 303 belong to the same chat group. The terminal sets the chat group to the private chat state in response to a trigger operation on the permission setting control 308, presented in an interface as displaying virtual obstacles around the first virtual object 301, the second virtual object 302, and the third virtual object 303.

In summary, in this embodiment of this application, a virtual social scene in which a virtual object corresponding to a social account performs social interaction is constructed. In the virtual social scene, the social account may control the virtual object to move to make a distance between virtual objects is less than a distance threshold, to create a chat group in a public state between at least two virtual objects whose distance is less than the distance threshold, where the chat group in the public state allows another virtual object to join. A permission setting control is displayed in a chat interface. The permission setting control is used for setting a group joining permission for the chat group. Further, the chat group may be set to a private chat state in response to a trigger operation on the permission setting control, where the chat group in the private chat state does not allow the another virtual object to join. According to the solution provided in this embodiment of this application, a chat permission setting opportunity may be provided in a virtual social scene for a chat group that is in a public state but has a private chat requirement, so that a social account in the chat group may set permission to join the chat group by using the permission setting control, optimizing chat group setting in the virtual social scene, enriching social types in the virtual social scene, and providing privacy protection for social interaction between social accounts corresponding to virtual objects in the chat group.

In a possible implementation, to further enrich a representation form of the chat group in the private chat state, the terminal may set a virtual object in the chat group in the private chat state to be visible or invisible to another virtual object, that is, the terminal may set the chat group to a public private chat state or a secret private chat state, to set the permission setting control to be in two control forms: a public private chat setting control and a secret private chat setting control.

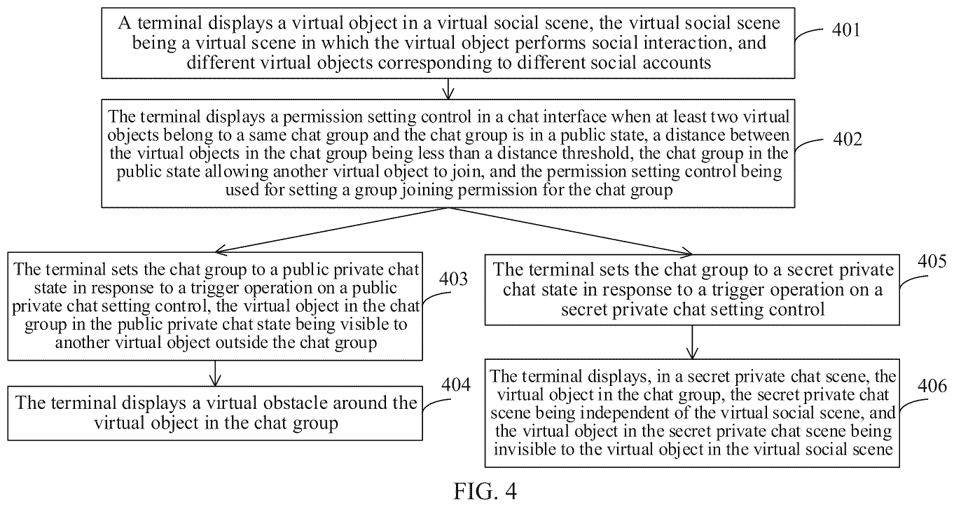

FIG. 4 is a flowchart of a virtual social scene display method according to an exemplary embodiment of this application. This embodiment is described by using an example in which the method is applied to a terminal shown in FIG. 1. The method includes the following operations.

Operation 401: The terminal displays a virtual object in a virtual social scene, the virtual social scene being a virtual scene in which the virtual object performs social interaction, and different virtual objects corresponding to different social accounts.

Operation 402: The terminal displays a permission setting control in a chat interface when at least two virtual objects belong to a same chat group and the chat group is in a public state, a distance between the virtual objects in the chat group being less than a distance threshold, the chat group in the public state allowing another virtual object to join, and the permission setting control being used for setting a group joining permission for the chat group. Operation 403 or 405 is performed.

For specific implementations of operations 401 and 402, refer to operations 201 and 202. Details are not described in this embodiment.

Operation 403: The terminal sets the chat group to a public private chat state in response to a trigger operation on a public private chat setting control, the virtual object in the chat group in the public private chat state being visible to another virtual object outside the chat group.

In a possible implementation, when receiving the trigger operation on the public private chat setting control, the terminal sets the chat group to the public private chat state, the virtual object in the chat group in the public private chat state being visible to the another virtual object outside the chat group. In other words, in the virtual social scene, the virtual object in the chat group can see the virtual object outside the chat group, and the virtual object outside the chat group can also see the virtual object in the chat group, but the virtual object outside the chat group cannot join the chat group.

A process in which the terminal sets the chat group to the public private chat state is similar to the process in which the terminal sets the chat group to the private chat state in the foregoing embodiment shown in FIG. 2, and details are not described herein again.

Operation 404: The terminal displays a virtual obstacle around the virtual object in the chat group.

In a possible implementation, because the virtual object in the chat group in the public private chat state is still in the virtual social scene, to help distinguish the chat group in the public state from the chat group in the public private chat state to prompt each virtual object in the virtual social scene, the terminal may additionally display the virtual obstacle around the virtual object in the chat group in the public private chat state, for example, surround the virtual object in the chat group by using a fence, so that the virtual object in the chat group may freely move within the virtual obstacle, and remain in the public private chat state, and the virtual object outside the chat group cannot enter the virtual obstacle, that is, cannot join the chat group in the public private chat state.

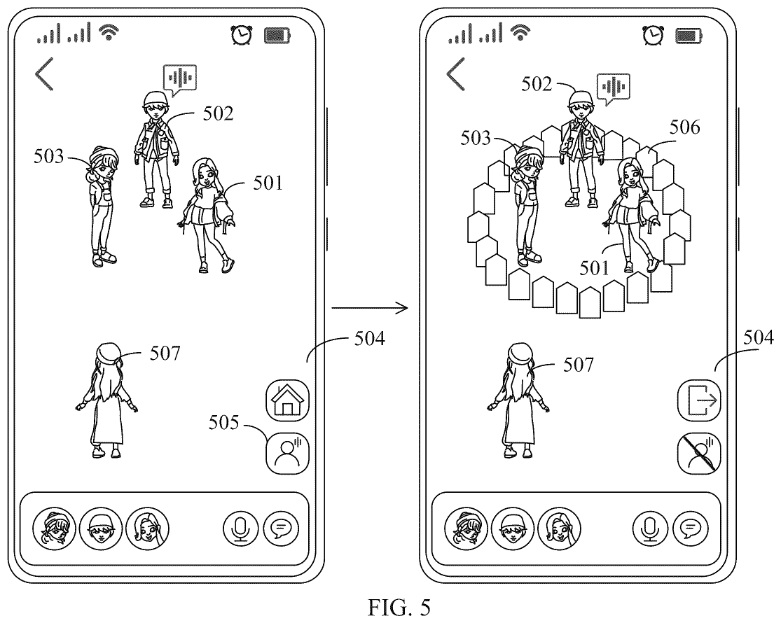

Schematically, as shown in FIG. 5, a first virtual object 501, a second virtual object 502, and a third virtual object 503 belong to a same chat group. The terminal sets the chat group to the public private chat state in response to a trigger operation on a public private chat setting control 505 in a chat interface 504, presented in an interface as displaying virtual obstacles 506 around the first virtual object 501, the second virtual object 502, and the third virtual object 503, so that a fourth virtual object 507 outside the virtual obstacles 506 cannot join the chat group, but the fourth virtual object 507 outside the virtual obstacles 506 can see the chat group in the virtual social scene, that is, see the first virtual object 501, the second virtual object 502, and the third virtual object 503 within the virtual obstacles 506.

In a possible implementation, when the chat group is in the public private chat state, the terminal may control the virtual object to leave the virtual obstacle, to exit the chat group. The terminal may control, in response to a trigger operation on a move control, a slide operation, or a tap operation, the virtual object in the chat group to move toward a boundary of the virtual obstacle, so that when the virtual object reaches the boundary of the virtual obstacle and continues to move outward, the terminal may control the virtual object to jump out of the virtual obstacle and exit the chat group.

In a possible implementation, to avoid a misoperation, when the virtual object reaches the boundary of the virtual obstacle, the terminal may display a leave prompt message, to prompt a social account that the virtual object is about to leave the virtual obstacle.

In a possible implementation, the virtual object in the chat group in the public private chat state is still in the virtual social scene. Therefore, to provide group joining opportunities to some virtual objects outside the chat group, the terminal may receive group joining requests transmitted by social accounts corresponding to the other virtual objects outside the chat group.

In a possible implementation, the terminal displays a third prompt message in the chat interface when the chat group is in the public private chat state and a group joining request transmitted by the another virtual object outside the chat group is received, the third prompt message being used for prompting a social account corresponding to the virtual object in the chat group that the another virtual object applies to join the current chat group. Therefore, when a social account corresponding to each virtual object in the chat group agrees to the group joining request, the terminal controls the another virtual object to join the current chat group.

In some embodiments, when the third prompt message is displayed in the chat interface, the terminal may further display a group joining request pop-up window in the chat interface. The group joining request pop-up window may include an agree control and a reject control, to determine whether the social account corresponding to the virtual object in the chat group agrees to the group joining request.

In an exemplary example, a terminal corresponding to a social account outside the chat group transmits a group joining request to the server. The group joining request is used for requesting to join the chat group. The server transmits, in response to the group joining request, the third prompt message to a terminal corresponding to a group leader in the chat group, so that the terminal corresponding to the group leader agrees to or rejects the group joining request; and the server determines, based on a response transmitted by the terminal corresponding to the group leader, whether to add a virtual object corresponding to the social account to the chat group. Alternatively, the server transmits the third prompt message to a terminal corresponding to each virtual object in the chat group, so that each terminal agrees to or rejects the group joining request; and the server determines, based on a response transmitted by each terminal, whether to add a virtual object corresponding to the social account to the chat group.

In a possible implementation, the chat group is created based on the distance between the virtual objects, and the virtual object in the chat group in the public private chat state is still in the virtual social scene, that is, a distance between the virtual object in the chat group and the virtual object outside the chat group may still be less than the distance threshold, for example, the virtual object in the chat group is close to an inner side of the virtual obstacle, and the virtual object outside the chat group is close to an outer side of the virtual obstacle. Therefore, to improve privacy of the chat group in the public private chat state, and prevent the virtual object outside the chat group from joining the chat group freely, when the chat group is switched from the public state to the public private chat state, the terminal may mark the virtual object in the chat group. In this way, even if the distance between the virtual object in the chat group and the virtual object outside the chat group is less than the distance threshold, a chat group still cannot be created between the virtual object in the chat group and the virtual object outside the chat group. Further, the terminal may unmark the virtual object in the chat group when the chat group is switched from the public private chat state to the public state, so that the virtual objects can continue to create a chat group again.

In a possible implementation, when a distance between the at least two virtual objects is less than the distance threshold, and none of the at least two virtual objects is marked, the terminal controls the at least two virtual objects to join the chat group in the public state, and displays the permission setting control in the chat interface.

In a possible implementation, in addition to marking the virtual object in the chat group, the terminal may further determine whether a connection line between the virtual objects passes through the virtual obstacle, to determine whether there is a virtual object among the two virtual objects that is in the chat group in the public private chat state.

In a possible implementation, when the distance between the at least two virtual objects is less than the distance threshold, and neither of pairwise connection lines of the at least two virtual objects passes through the virtual obstacle, the terminal controls the at least two virtual objects to join the chat group in the public state, and displays the permission setting control in the chat interface.

Operation 405: The terminal sets the chat group to a secret private chat state in response to a trigger operation on a secret private chat setting control.

In a possible implementation, a social account corresponding to a virtual object in a chat group in a private chat state may not want another virtual object in the virtual social scene to see the current chat group, that is, a chat group in the public state has a requirement for a private chat. Therefore, the terminal may display the secret private chat setting control in the chat interface. In this way, when receiving the trigger operation on the secret private chat setting control, the terminal may set the chat group to the secret private chat state. Similarly, the another virtual object outside the chat group cannot join the chat group.

A process in which the terminal sets the chat group to the secret private chat state is similar to the process in which the terminal sets the chat group to the private chat state in the foregoing embodiment shown in FIG. 2, and details are not described herein again.

Operation 406: The terminal displays, in a secret private chat scene, the virtual object in the chat group, the secret private chat scene being independent of the virtual social scene, and the virtual object in the secret private chat scene being invisible to the virtual object in the virtual social scene.

In a possible implementation, to meet a chat requirement of the chat group in the secret private chat state, a terminal is set with the secret private chat scene. The secret private chat scene is independent of the virtual social scene. In some embodiments, the secret private chat scene is a virtual scene in which the virtual object in the chat group in the secret private chat state performs social interaction, and is a virtual environment displayed (or provided) when a target application is run on the terminal. The virtual environment may be a simulated environment of a real world, a semi-simulated semi-fictional environment, or an entirely fictional environment. The virtual environment may be any one of a two-dimensional virtual environment, a 2.5-dimensional virtual environment, and a three-dimensional virtual environment. This is not limited in this application.

In some embodiments, the secret private chat scene may be customized by a user, that is, secret private chat scenes displayed during login with different social accounts may be the same or different. For example, a social account “Zhang San” sets the secret private chat scene to a virtual park, and a social account “Li Si” sets the secret private chat scene to a virtual restaurant.

In a possible implementation, the terminal displays, in the secret private chat scene, the virtual object in the chat group. The virtual object in the secret private chat scene is invisible to the virtual object in the virtual social scene. In other words, the virtual object in the secret private chat scene cannot see the virtual object in the virtual social scene, nor can the virtual object in the virtual social scene see the virtual object in the secret private chat scene.

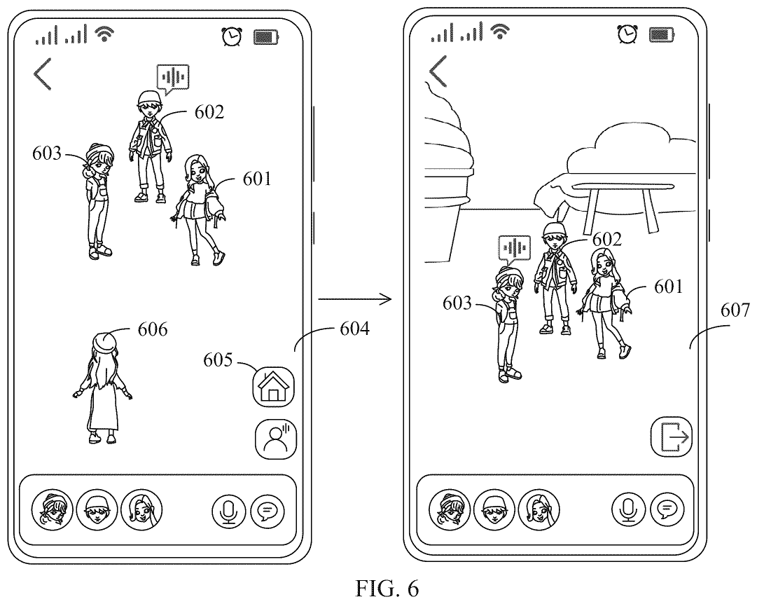

Schematically, as shown in FIG. 6, a first virtual object 601, a second virtual object 602, and a third virtual object 603 belong to a same chat group. The terminal sets the chat group to the secret private chat state in response to a trigger operation on a secret private chat setting control 605 in a chat interface 604, presented in an interface as displaying the first virtual object 601, the second virtual object 602, and the third virtual object 603 in a secret private chat scene 607, so that the first virtual object 601, the second virtual object 602, and the third virtual object 603 in the secret private chat scene 607 cannot see a fourth virtual object 606 in the virtual social scene, and the fourth virtual object 606 in the virtual social scene also cannot see the first virtual object 601, the second virtual object 602, and the third virtual object 603 in the secret private scene 607.

In the foregoing embodiment, permission setting controls in two control forms, that is, the public private chat setting control and the secret private chat setting control, are displayed in the chat interface, so that the chat group can be set to two states, that is, the public private chat state or the secret private chat state, optimizing chat group setting in the virtual social scene and enriching representation forms of the chat group in the private chat state.

In a possible implementation, there are the at least two virtual objects in the chat group in the public state, and social accounts corresponding to different virtual objects may have different setting requirements on a status of the chat group. Therefore, to fully consider an opinion of each social account in the chat group for setting the chat group, when a trigger operation of one social account on the permission setting control is received, the opinion of each social account for setting the chat group may be determined by transmitting a voting notification to another social account, to set the status of the chat group based on a voting result.

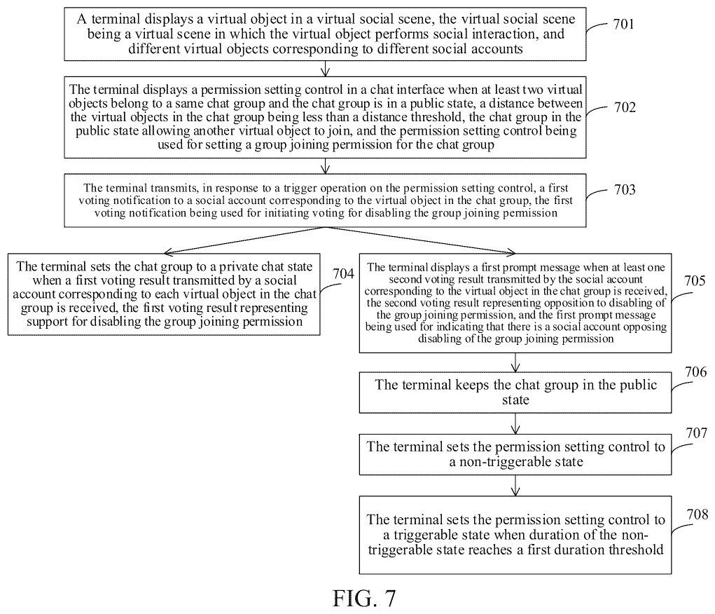

FIG. 7 is a flowchart of a virtual social scene display method according to another exemplary embodiment of this application. This embodiment is described by using an example in which the method is applied to a terminal shown in FIG. 1. The method includes the following operations.

Operation 701: The terminal displays a virtual object in a virtual social scene, the virtual social scene being a virtual scene in which the virtual object performs social interaction, and different virtual objects corresponding to different social accounts.

Operation 702: The terminal displays a permission setting control in a chat interface when at least two virtual objects belong to a same chat group and the chat group is in a public state, a distance between the virtual objects in the chat group being less than a distance threshold, the chat group in the public state allowing another virtual object to join, and the permission setting control being used for setting a group joining permission for the chat group.

For specific implementations of operations 701 and 702, refer to operations 201 and 202. Details are not described in this embodiment.

Operation 703: The terminal transmits, in response to a trigger operation on the permission setting control, a first voting notification to a social account corresponding to the virtual object in the chat group, the first voting notification being used for initiating voting for disabling the group joining permission. Operation 704 or 705 is performed.

In a possible implementation, a first virtual object corresponding to a first social account belongs to the chat group in the private chat state. When receiving a trigger operation of the first social account on the permission setting control, a first terminal corresponding to the first social account generates first voting data. The first voting data includes information about the first social account that initiates voting and a voting type. A current voting type is whether to agree to disable the group joining permission. Further, the first terminal transmits the first voting data to a server, and transmits, via the server, the first voting notification to a social account corresponding to another virtual object in the chat group. The first voting notification is used for initiating voting for disabling the group joining permission. In some embodiments, the first voting notification may include an account nickname of the first social account, the voting type, voting duration, and the like.

In a possible implementation, a second virtual object corresponding to a second social account belongs to the same chat group as the first virtual object. When a second terminal corresponding to the second social account receives the first voting notification, the second terminal displays a first voting window in a chat interface. In some embodiments, the account nickname of the first social account, the voting type, the voting duration, and a voting control are displayed in the first voting window. The voting control includes an agree control and a reject control.

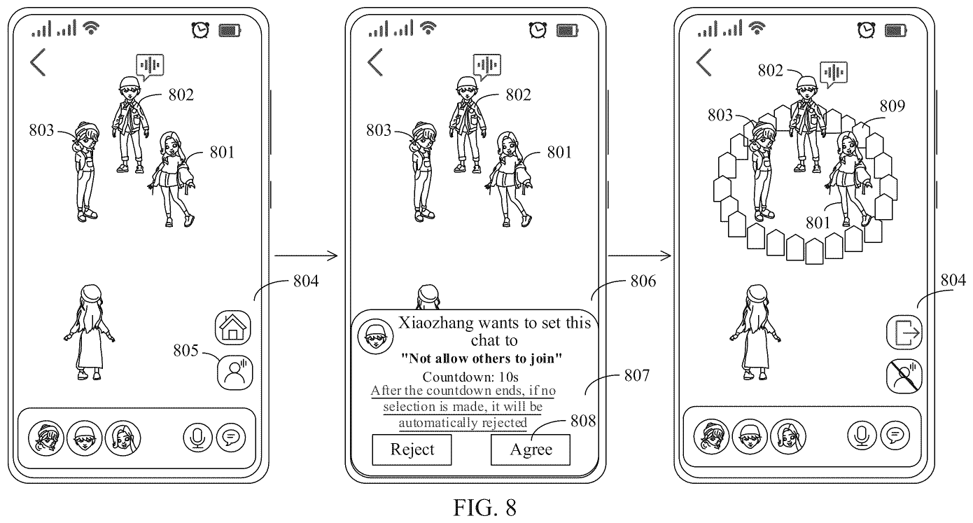

Schematically, as shown in FIG. 8, a first virtual object 801, a second virtual object 802, and a third virtual object 803 belong to a same chat group, a first chat interface 804 is a chat interface of a social account corresponding to the second virtual object 802, and a second chat interface 806 is a chat interface of a social account corresponding to the first virtual object 801. When receiving a trigger operation of a user on a public private chat setting control 805 in the first chat interface 804, a terminal corresponding to the second virtual object 802 transmits a first voting notification to the social account corresponding to the first virtual object 801 and a social account corresponding to the third virtual object 803 in the chat group, so that a terminal corresponding to the first virtual object 801 displays a first voting window 807 in the second chat interface 806, and the social account corresponding to the first virtual object 801 may vote in the first voting window 807.

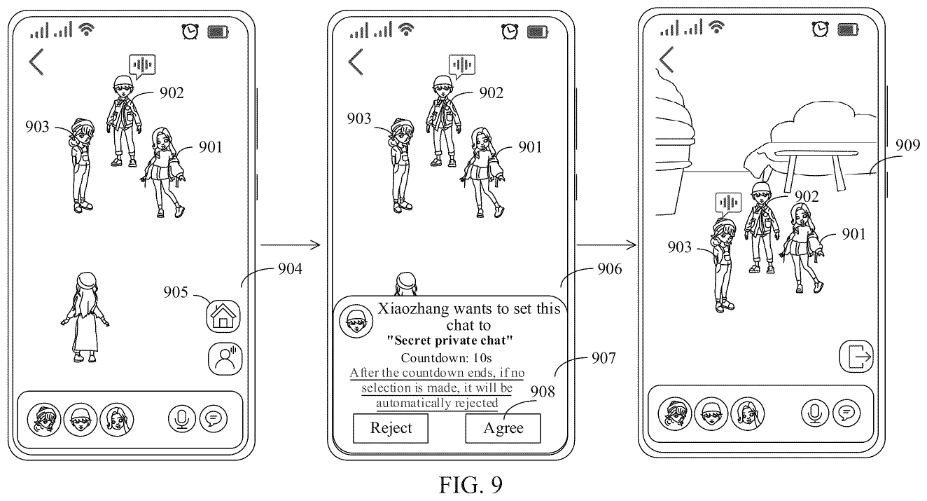

Schematically, as shown in FIG. 9, a first virtual object 901, a second virtual object 902, and a third virtual object 903 belong to a same chat group, a first chat interface 904 is a chat interface of a social account corresponding to the second virtual object 902, and a second chat interface 906 is a chat interface of a social account corresponding to the first virtual object 901. When receiving a trigger operation of a user on a secret private chat setting control 905 in the first chat interface 904, a terminal corresponding to the second virtual object 902 transmits a first voting notification to the social account corresponding to the first virtual object 901 and a social account corresponding to the third virtual object 903 in the chat group, so that a terminal corresponding to the first virtual object 901 displays a first voting window 907 in the second chat interface 906, and the social account corresponding to the first virtual object 901 may vote in the first voting window 907.

Operation 704: The terminal sets the chat group to a private chat state when a first voting result transmitted by a social account corresponding to each virtual object in the chat group is received, the first voting result representing support for disabling the group joining permission.

In a possible implementation, a social account corresponding to a virtual object in a same chat group may have a different opinion on whether to set the chat group to the private chat state. Therefore, to fully consider opinions of different social accounts and improve accuracy of setting the chat group, the terminal sets the chat group to the private chat state only when the first voting result transmitted by the social account corresponding to each virtual object in the chat group is received. The first voting result represents that the social account supports disabling of the group joining permission for the chat group.

In a possible implementation, the second terminal corresponding to the second social account receives a trigger operation of the user on the agree control, that is, generates a first voting result, and transmits the first voting result to the server. In some embodiments, the server may collect statistics on a quantity of received first voting results and information about social accounts corresponding to the first voting results; and when determining that social accounts corresponding to all virtual objects in the chat group transmit first voting results, the server transmits a final statistics result to terminals corresponding to the social accounts, so that the terminals set the chat group to the private chat state. In some embodiments, the server may alternatively directly transmit a received first voting result and information about a corresponding social account to the terminal, the terminal collects statistics on the voting result, and when determining that social accounts corresponding to all virtual objects in the chat group transmit first voting results, the terminal sets the chat group to the private chat state.

In a possible implementation, to improve voting efficiency of each social account, when displaying the first voting window for the user to vote, the terminal may further display a voting countdown in the first voting window. When the voting countdown ends and a trigger operation of the user on the agree control or the reject control is not received, the terminal determines by default that the social account supports disabling of the group joining permission, and transmits the first voting result.

Schematically, as shown in FIG. 8, when the terminal corresponding to the first virtual object 801 receives a trigger operation of the user on an agree control 808 in the first voting window 807 in the second chat interface 806, the terminal corresponding to the first virtual object 801 transmits a first voting result to the terminal corresponding to the second virtual object 802. When the terminal corresponding to the second virtual object 802 receives first voting results transmitted by social accounts corresponding to all virtual objects in the chat group, the terminal corresponding to the second virtual object 802 sets the chat group to a public private chat state, and displays virtual obstacles 809 around the first virtual object 801, the second virtual object 802, and the third virtual object 803.

Schematically, as shown in FIG. 9, when the terminal corresponding to the first virtual object 901 receives a trigger operation of the user on an agree control 908 in the first voting window 907 in the second chat interface 906, the terminal corresponding to the first virtual object 901 transmits a first voting result to the terminal corresponding to the second virtual object 902. When the terminal corresponding to the second virtual object 902 receives first voting results transmitted by social accounts corresponding to all virtual objects in the chat group, the terminal corresponding to the second virtual object 902 sets the chat group to a secret private chat state, and displays the first virtual object 901, the second virtual object 902, and the third virtual object 903 in a secret private chat scene 909.

Operation 705: The terminal displays a first prompt message when at least one second voting result transmitted by the social account corresponding to the virtual object in the chat group is received, the second voting result representing opposition to disabling of the group joining permission, and the first prompt message being used for indicating that there is a social account opposing disabling of the group joining permission.

In a possible implementation, when the at least one second voting result transmitted by the social account corresponding to the virtual object in the chat group is received, the second voting result represents that the social account opposes disabling of the group joining permission, that is, represents that there is a social account in the chat group that does not agree to disable the group joining permission. Therefore, to prompt the first social account that initiates voting and another social account that participates in voting in the chat group, the terminal displays the first prompt message. The first prompt message is used for indicating that there is the social account opposing disabling of the group joining permission.

In some embodiments, the first prompt message may include information about the social account transmitting the second voting result, and a quantity of social accounts transmitting second voting results. In some embodiments, to protect the account information of the social account transmitting the second voting result, the first prompt message may alternatively be directly “someone opposes disabling of the group joining permission”. This is not limited in this embodiment of this application.

In a possible implementation, to improve voting efficiency of each social account, when displaying the first voting window for the user to vote, the terminal may further display a voting countdown in the first voting window. When the voting countdown ends and a trigger operation of the user on the agree control or the reject control is not received, the terminal determines by default that the social account opposes disabling of the group joining permission, and transmits the second voting result.

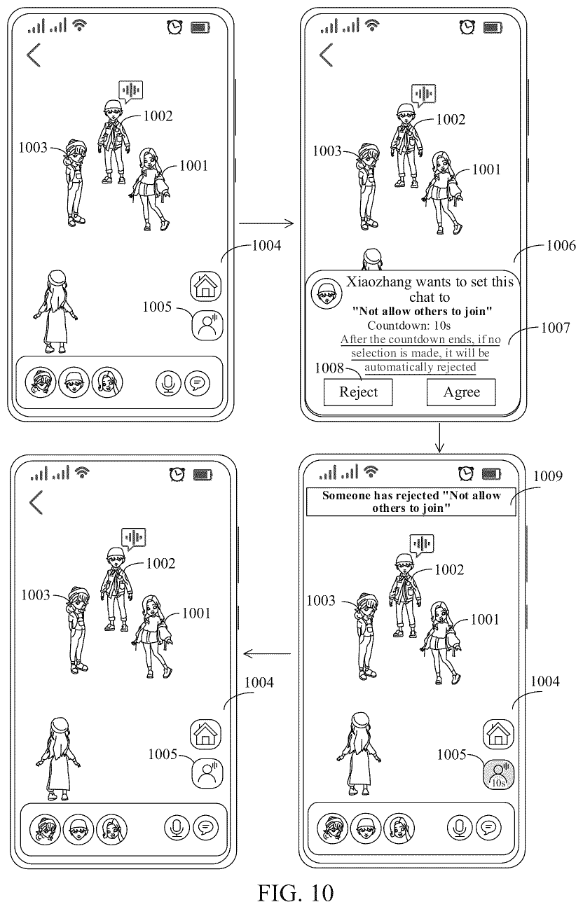

Schematically, as shown in FIG. 10, a first virtual object 1001, a second virtual object 1002, and a third virtual object 1003 belong to a same chat group, a first chat interface 1004 is a chat interface of a social account corresponding to the second virtual object 1002, and a second chat interface 1006 is a chat interface of a social account corresponding to the first virtual object 1001. When receiving a trigger operation of a user on a public private chat setting control 1005 in the first chat interface 1004, a terminal corresponding to the second virtual object 1002 transmits a first voting notification to a social account corresponding to the first virtual object 1001 in the chat group and a social account corresponding to the third virtual object 1003, so that a terminal corresponding to the first virtual object 1001 displays a first voting window 1007 in the second chat interface 1006. When the terminal corresponding to the first virtual object 1001 receives a trigger operation of a user on a reject control 1008 in the first voting window 1007, the terminal corresponding to the first virtual object 1001 transmits a second voting result to the terminal corresponding to the second virtual object 1002. When the terminal corresponding to the second virtual object 1002 receives the second voting result, the terminal corresponding to the second virtual object 1002 displays a first prompt message 1009 in the first chat interface 1004, to prompt that there is a social account opposing disabling of the group joining permission, and rejects to set the chat group to a public private chat state.

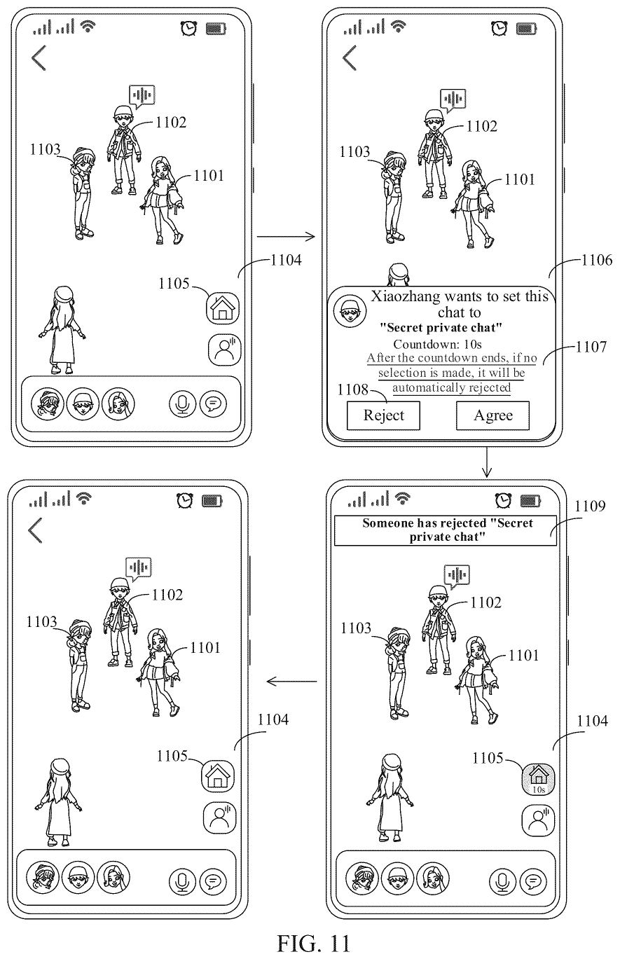

Schematically, as shown in FIG. 11, a first virtual object 1101, a second virtual object 1102, and a third virtual object 1103 belong to a same chat group, a first chat interface 1104 is a chat interface of a social account corresponding to the second virtual object 1102, and a second chat interface 1106 is a chat interface of a social account corresponding to the first virtual object 1101. When receiving a trigger operation of a user on a secret private chat setting control 1105 in the first chat interface 1104, a terminal corresponding to the second virtual object 1102 transmits a first voting notification to a social account corresponding to the first virtual object 1101 and a social account corresponding to the third virtual object 1103 in the chat group, so that a terminal corresponding to the first virtual object 1101 displays a first voting window 1107 in the second chat interface 1106. When the terminal corresponding to the first virtual object 1101 receives a trigger operation of a user on a reject control 1108 in the first voting window 1107, the terminal corresponding to the first virtual object 1101 transmits a second voting result to the terminal corresponding to the second virtual object 1102. When the terminal corresponding to the second virtual object 1102 receives the second voting result, the terminal corresponding to the second virtual object 1102 displays a first prompt message 1109 in the first chat interface 1104, to prompt that there is a social account opposing disabling of the group joining permission, and rejects to set the chat group to a secret private chat state.

Operation 706: The terminal keeps the chat group in the public state.

Further, when at least one social account opposes disabling of the group joining permission, the terminal controls the chat group to remain in the public state, so that another virtual object in the virtual social scene can still join the chat group by adjusting the distance between the virtual objects.

Schematically, as shown in FIG. 10, when the terminal corresponding to the second virtual object 1002 receives the second voting result, the terminal corresponding to the second virtual object 1002 keeps the chat group in the public state, that is, the first virtual object 1001, the second virtual object 1002, and the third virtual object 1003 continue to be displayed in the virtual social scene.

Schematically, as shown in FIG. 11, when the terminal corresponding to the second virtual object 1102 receives the second voting result, the terminal corresponding to the second virtual object 1102 keeps the chat group in the public state, that is, the first virtual object 1101, the second virtual object 1102, and the third virtual object 1103 continue to be displayed in the virtual social scene.

Operation 707: The terminal sets the permission setting control to a non-triggerable state.

In a possible implementation, to avoid a social account in the chat group frequently initiating voting for disabling the group joining permission, when at least one social account opposes disabling of the group joining permission, the terminal may set the permission setting control to the non-triggerable state. In other words, in the non-triggerable state, the social account cannot initiate, by using the permission setting control, voting for disabling the group joining permission.

In some embodiments, the non-triggerable state may be set for only a terminal of a social account that initiates voting for disabling the group joining permission, or may be set for terminals of all social accounts in the current chat group. This is not limited in this embodiment of this application.

Operation 708: The terminal sets the permission setting control to a triggerable state when duration of the non-triggerable state reaches a first duration threshold.

In a possible implementation, the social account corresponding to the virtual object in the chat group may only temporarily oppose disabling of the chat group joining permission, that is, the chat group still has a requirement of disabling the chat group joining permission and entering the private chat state. Therefore, the terminal sets the duration threshold for the duration of the non-triggerable state of the permission setting control. In this way, when the duration of the non-triggerable state reaches the first duration threshold, the terminal resets the permission setting control to the triggerable state.

Schematically, as shown in FIG. 10, when the terminal corresponding to the second virtual object 1002 receives the second voting result, the public private chat setting control 1005 is set to the non-triggerable state, and 10-second countdown is performed for the non-triggerable state. When 10-second countdown ends, the terminal sets the public private chat setting control 1005 to the triggerable state.

Schematically, as shown in FIG. 11, when the terminal corresponding to the second virtual object 1102 receives the second voting result, the terminal sets the secret private chat setting control 1105 to the non-triggerable state, and performs 10-second countdown for the non-triggerable state. When 10-second countdown ends, the terminal sets the secret private chat setting control 1105 to the triggerable state.

In a possible implementation, after the chat group is created between the at least two virtual objects, to avoid frequent setting of the chat group joining permission for the chat group, a quantity of times of setting the chat group joining permission may further be limited, that is, a quantity of times of switching the permission setting control from the non-triggerable state to the triggerable state is limited. When the quantity of times of switching reaches a threshold, the terminal may keep the permission setting control in the non-triggerable state.

In this embodiment of this application, an example in which the chat group is set to the private chat state when social accounts corresponding to all virtual objects in the chat group support disabling of the group joining permission is used for description. However, in some other embodiments, it is not required that the social accounts corresponding to all the virtual objects support disabling of the group joining permission. Therefore, in a possible implementation, that the terminal sets the chat group to a private chat state includes: The terminal transmits, in response to a trigger operation on the permission setting control, the first voting notification to the social account corresponding to the virtual object in the chat group, the first voting notification being used for initiating voting for disabling the group joining permission. The terminal sets the chat group to the private chat state when it is determined, based on a voting result transmitted by the social account corresponding to the virtual object in the chat group, that there is support for disabling the group joining permission.

In an exemplary example, it is only required that a quantity of social accounts supporting disabling of the group joining permission is greater than a quantity of social accounts opposing disabling of the group joining permission. Therefore, if the terminal determines, based on the voting result transmitted by the social account corresponding to the virtual object in the chat group, that the quantity of social accounts supporting disabling of the group joining permission is greater than the quantity of social accounts opposing disabling of the group joining permission, the terminal sets the chat group to the private chat state.

In the foregoing embodiment, in the process of setting the chat group from the public state to the private chat state, to fully consider opinions of the social accounts corresponding to the virtual objects in the chat group, the voting result corresponding to each social account is determined by initiating the first voting notification when the trigger operation on the permission setting control is received, to determine, based on the voting result, whether to adjust a status of the chat group, optimizing the process of setting the status of the chat group.

In a possible implementation, when the chat group enters the private chat state, there may be a virtual object in the chat group that intends to exit the chat group, and a social account corresponding to another virtual object in the chat group still has a requirement for the private chat. Therefore, when the chat group enters the private chat state, the terminal may display a leave control in the chat interface. In this way, the terminal may control, in response to a trigger operation on the leave control, the virtual object to exit the chat group.

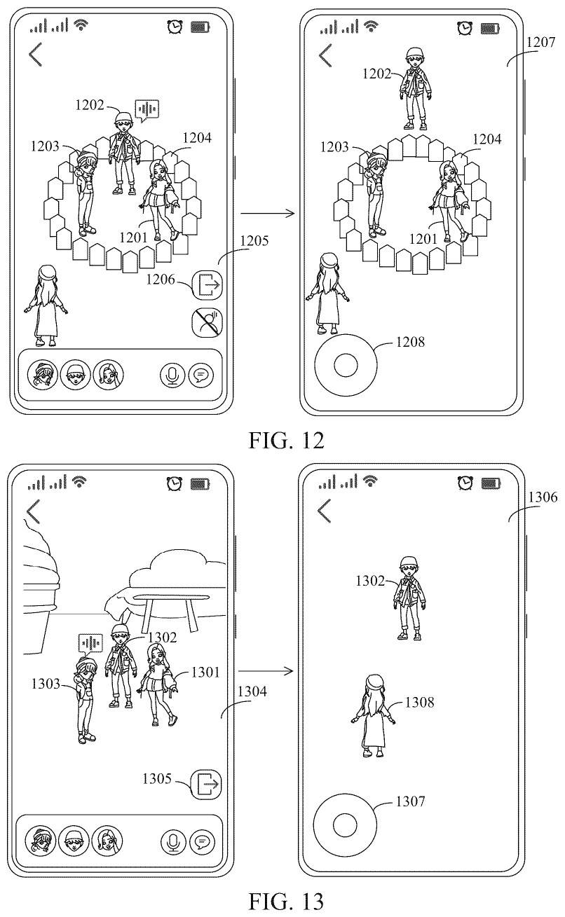

Schematically, as shown in FIG. 12, a first virtual object 1201, a second virtual object 1202, and a third virtual object 1203 belong to a chat group in the public private chat state. Virtual obstacles 1204 are displayed around the first virtual object 1201, the second virtual object 1202, and the third virtual object 1203. When receiving a trigger operation of the user on a leave control 1206 in a chat interface 1205, the terminal controls the second virtual object 1202 to exit the chat group and jump out of the virtual obstacles 1204, so that the user may trigger a move control 1208, perform a slide operation, or perform a tap operation, to control the second virtual object 1202 to move in a virtual social scene 1207, and create a chat group with another virtual object.

Schematically, as shown in FIG. 13, a first virtual object 1301, a second virtual object 1302, and a third virtual object 1303 belong to a chat group in the secret private chat state. The first virtual object 1301, the second virtual object 1302, and the third virtual object 1303 are located in a secret private chat scene 1304. When receiving a trigger operation of the user on a leave control 1305, the terminal controls the second virtual object 1302 to exit the chat group, and displays the second virtual object 1302 in a virtual social scene 1306. A fourth virtual object 1308 can see the second virtual object 1302 in the virtual social scene 1306. Therefore, the user can trigger a move control 1307, perform a slide operation, or perform a tap operation, to control the second virtual object 1302 to move in the virtual social scene 1306, and create a chat group with another virtual object.

In a possible implementation, after the virtual object in the chat group sequentially exits the chat group based on a trigger operation of the social account on the leave control, to improve efficiency of disbanding the chat group, the terminal may directly disband the chat group when a quantity of virtual objects in the chat group is less than a quantity threshold. For example, when there is only one virtual object remaining in the chat group, because only one virtual object cannot chat, the terminal directly disbands the chat group.

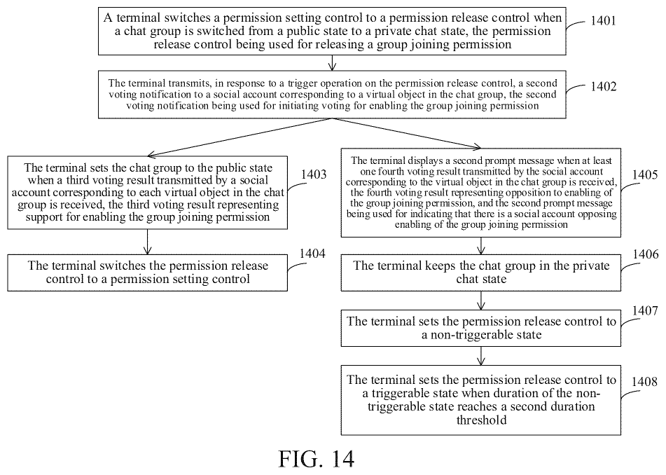

In a possible implementation, when the chat group enters the private chat state, the chat group may need to return to the public state again. Therefore, when the chat group enters the private chat state, the terminal may switch the permission setting control to a permission release control in the chat interface. In this way, the terminal may set the chat group to the public state again in response to a trigger operation on the permission release control. As shown in FIG. 14, the process includes the following operations:

Operation 1401: The terminal switches the permission setting control to the permission release control when the chat group is switched from the public state to the private chat state, the permission release control being used for releasing the group joining permission.

In a possible implementation, to make it convenient for the social account corresponding to the virtual object in the chat group to adjust the status of the chat group at any time, the chat group is reset to the public state. When the chat group is switched from the public state to the private chat state, the terminal may switch the permission setting control in the chat interface to the permission release control. The permission release control may be used for releasing the group joining permission.

In some embodiments, the public private chat setting control is correspondingly switched to a public private chat release control, and the secret private chat setting control is correspondingly switched to a secret private chat release control.

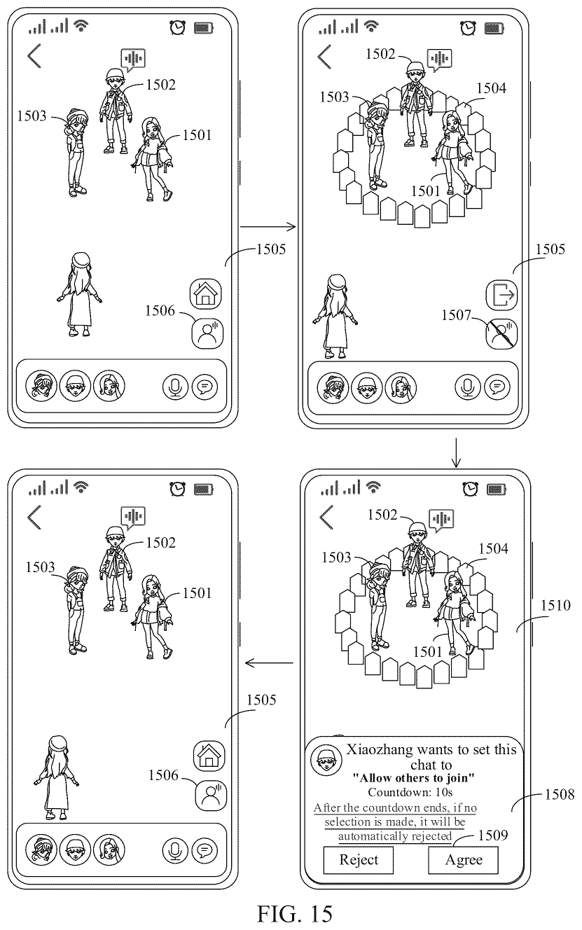

Schematically, as shown in FIG. 15, distances between a first virtual object 1501, a second virtual object 1502, and a third virtual object 1503 are less than the distance threshold. When receiving a trigger operation of the user on a public private chat setting control 1506 in a first chat interface 1505, the terminal controls the first virtual object 1501, the second virtual object 1502, and the third virtual object 1503 to join a same chat group, displays virtual obstacles 1504 around the first virtual object 1501, the second virtual object 1502, and the third virtual object 1503, and switches the public private chat setting control 1506 to a public private chat release control 1507.

Operation 1402: The terminal transmits, in response to a trigger operation on the permission release control, a second voting notification to the social account corresponding to the virtual object in the chat group, the second voting notification being used for initiating voting for enabling the group joining permission. Operation 1403 or 1405 is performed.

In a possible implementation, the first virtual object corresponding to the first social account belongs to the chat group in the private chat state. When receiving a trigger operation of the first social account on the permission release control, the first terminal corresponding to the first social account generates second voting data. The second voting data includes the information about the first social account that initiates voting and a voting type. A current voting type is whether to agree to enable the group joining permission. Further, the first terminal transmits the second voting data to the server, and transmits, via the server, the second voting notification to a social account corresponding to another virtual object in the chat group. The second voting notification is used for initiating voting for enabling the group joining permission. In some embodiments, the second voting notification may include the account nickname of the first social account, the voting type, voting duration, and the like.

In a possible implementation, the second virtual object corresponding to the second social account belongs to the same chat group as the first virtual object. When the second terminal corresponding to the second social account receives the second voting notification, the second terminal displays a second voting window in a chat interface. In some embodiments, the account nickname of the first social account, the voting type, the voting duration, and a voting control are displayed in the second voting window. The voting control includes an agree control and a reject control.

Schematically, as shown in FIG. 15, a first chat interface 1505 is a chat interface of a social account corresponding to the second virtual object 1502, and a second chat interface 1510 is a chat interface of a social account corresponding to the first virtual object 1501. When receiving a trigger operation of a user on the public private chat release control 1507 in the first chat interface 1505, a terminal corresponding to the second virtual object 1502 transmits the second voting notification to the social account corresponding to the first virtual object 1501 and a social account corresponding to the third virtual object 1503 in the chat group, so that a terminal corresponding to the first virtual object 1501 displays a second voting window 1508 in the second chat interface 1510. The social account corresponding to the first virtual object 1501 may perform voting in the second voting window 1508.

Operation 1403: The terminal sets the chat group to the public state when a third voting result transmitted by the social account corresponding to each virtual object in the chat group is received, the third voting result representing support for enabling the group joining permission.

In a possible implementation, a social account corresponding to a virtual object in a same chat group may have a different opinion on whether to reset the chat group to the public state. Therefore, to fully consider opinions of different social accounts and improve accuracy of setting the chat group, the terminal resets the chat group to the public state only when the third voting result transmitted by the social account corresponding to each virtual object in the chat group is received. The third voting result represents that the social account supports enabling of the group joining permission for the chat group.

In a possible implementation, the second terminal corresponding to the second social account receives a trigger operation of the user on the agree control, that is, generates a third voting result, and transmits the third voting result to the server. In some embodiments, the server may collect statistics on a quantity of received third voting results and information about social accounts corresponding to the third voting results; and when determining that social accounts corresponding to all virtual objects in the chat group transmit third voting results, the server transmits a final statistics result to terminals corresponding to the social accounts, so that the terminals set the chat group to the public state. In some embodiments, the server may alternatively directly transmit a received third voting result and information about a corresponding social account to the terminal, the terminal collects statistics on the voting result, and when determining that social accounts corresponding to all virtual objects in the chat group transmit third voting results, the terminal sets the chat group to the public state.

In a possible implementation, to improve voting efficiency of each social account, when displaying the second voting window for the user to vote, the terminal may further display a voting countdown in the second voting window. When the voting countdown ends and a trigger operation of the user on the agree control or the reject control is not received, the terminal determines by default that the social account supports enabling of the group joining permission, and transmits the third voting result.

Schematically, as shown in FIG. 15, when the terminal corresponding to the first virtual object 1501 receives a trigger operation of the user on an agree control 1509 in the second voting window 1508 in the second chat interface 1510, the terminal corresponding to the first virtual object 1501 transmits a third voting result to the terminal corresponding to the second virtual object 1502. When the terminal corresponding to the second virtual object 1502 receives third voting results transmitted by social accounts corresponding to all virtual objects in the chat group, the terminal corresponding to the second virtual object 1502 sets the chat group to the public state, and undisplays virtual obstacles 1504 around the first virtual object 1501, the second virtual object 1502, and the third virtual object 1503.

Operation 1404: The terminal switches the permission release control to the permission setting control.

Further, to help the social account corresponding to the virtual object in the chat group to enter the private chat state again, the terminal switches the permission release control to the permission setting control.

In some embodiments, the public private chat release control is correspondingly switched to the public private chat setting control, and the secret private chat release control is correspondingly switched to the secret private chat setting control.

Schematically, as shown in FIG. 15, when the chat group is reset to the public state, the terminal switches the public private chat release control 1507 to the public private chat setting control 1506.

Operation 1405: The terminal displays a second prompt message when at least one fourth voting result transmitted by the social account corresponding to the virtual object in the chat group is received, the fourth voting result representing opposition to enabling of the group joining permission, and the second prompt message being used for indicating that there is a social account opposing enabling of the group joining permission.

In a possible implementation, when the at least one fourth voting result transmitted by the social account corresponding to the virtual object in the chat group is received, the fourth voting result represents that the social account opposes enabling of the group joining permission, that is, represents that there is a social account in the chat group that does not agree to enable the group joining permission. Therefore, to prompt the first social account that initiates voting and another social account that participates in voting in the chat group, the terminal displays the second prompt message. The second prompt message is used for indicating that there is the social account opposing enabling of the group joining permission.

In some embodiments, the second prompt message may include information about the social account transmitting the fourth voting result, and a quantity of social accounts transmitting fourth voting results. In some embodiments, to protect the account information of the social account transmitting the fourth voting result, the second prompt message may alternatively be directly “someone opposes enabling of the group joining permission”. This is not limited in this embodiment of this application.

In a possible implementation, to improve voting efficiency of each social account, when displaying the second voting window for the user to vote, the terminal may further display a voting countdown in the second voting window. When the voting countdown ends and a trigger operation of the user on the agree control or the reject control is not received, the terminal determines by default that the social account opposes enabling of the group joining permission, and transmits the fourth voting result.

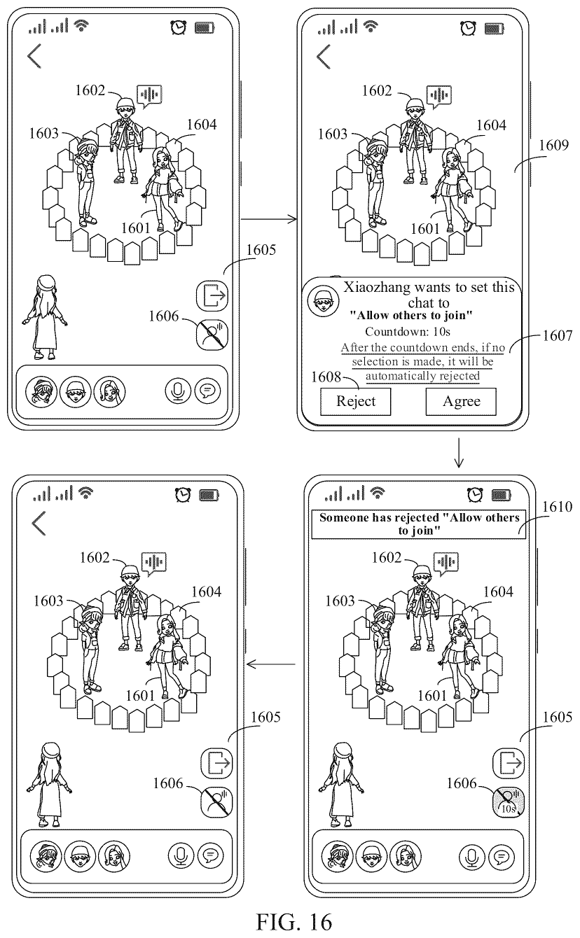

Schematically, as shown in FIG. 16, a first virtual object 1601, a second virtual object 1602, and a third virtual object 1603 belong to a chat group in the public private chat state. Virtual obstacles 1604 are displayed around the first virtual object 1601, the second virtual object 1602, and the third virtual object 1603. A first chat interface 1605 is a chat interface of a social account corresponding to the second virtual object 1602, and a second chat interface 1609 is a chat interface of a social account corresponding to the first virtual object 1601. When receiving a trigger operation of a user on a public private chat release control 1606 in the first chat interface 1605, a terminal corresponding to the second virtual object 1602 transmits a second voting notification to a social account corresponding to the first virtual object 1601 and a social account corresponding to the third virtual object 1603 in the chat group, so that a terminal corresponding to the first virtual object 1601 displays a second voting window 1607 in the second chat interface 1609. When the terminal corresponding to the first virtual object 1601 receives a trigger operation of a user on a reject control 1608 in the second voting window 1607, the terminal corresponding to the first virtual object 1601 transmits a fourth voting result to the terminal corresponding to the second virtual object 1602. When the terminal corresponding to the second virtual object 1602 receives the fourth voting result, the terminal corresponding to the second virtual object 1602 displays a second prompt message 1610 in the first chat interface 1605, to prompt that there is a social account opposing enabling of the group joining permission, that is, there is a social account rejecting another virtual object to join the chat group.

Operation 1406: The terminal keeps the chat group in the private chat state.

Further, when at least one social account opposes enabling of the group joining permission, the terminal controls the chat group to remain in the private chat state, so that another virtual object in the virtual social scene still cannot join the chat group by adjusting the distance between the virtual objects.

Schematically, as shown in FIG. 16, when the terminal corresponding to the second virtual object 1602 receives the fourth voting result, the terminal corresponding to the second virtual object 1602 keeps the chat group in the public private chat state, that is, the virtual obstacles 1604 continue to be displayed around the first virtual object 1601, the second virtual object 1602, and the third virtual object 1603.

Operation 1407: The terminal sets the permission release control to a non-triggerable state.

In a possible implementation, to avoid a social account in the chat group frequently initiating voting for enabling the group joining permission, when at least one social account opposes enabling of the group joining permission, the terminal may set the permission release control to the non-triggerable state. In other words, in the non-triggerable state, the social account cannot initiate, by using the permission release control, voting for enabling the group joining permission.

In some embodiments, the non-triggerable state may be set for only a terminal of a social account that initiates voting for enabling the group joining permission, or may be set for terminals of all social accounts in the current chat group. This is not limited in this embodiment of this application.

Operation 1408: The terminal sets the permission release control to the triggerable state when duration of the non-triggerable state reaches a second duration threshold.

In a possible implementation, the social account corresponding to the virtual object in the chat group may only temporarily oppose enabling of the chat group joining permission, that is, the chat group still has a requirement of enabling the chat group joining permission and returning to the public state. Therefore, the terminal sets the second duration threshold for the duration of the non-triggerable state of the permission release control. In this way, when the duration of the non-triggerable state reaches the second duration threshold, the terminal resets the permission release control to the triggerable state.

Schematically, as shown in FIG. 16, when the terminal corresponding to the second virtual object 1602 receives the fourth voting result, the public private chat release control 1606 is set to the non-triggerable state, and 10-second countdown is performed for the non-triggerable state. When 10-second countdown ends, the terminal sets the public private chat release control 1606 to the triggerable state.

In this embodiment of this application, an example in which the chat group is set to the public state when social accounts corresponding to all virtual objects in the chat group support enabling of the group joining permission is used for description. However, in some other embodiments, it is not required that the social accounts corresponding to all the virtual objects support enabling of the group joining permission. Therefore, in a possible implementation, that the terminal sets the chat group to the public state includes: The terminal transmits, in response to the trigger operation on the permission release control, the second voting notification to the social account corresponding to the virtual object in the chat group, the second voting notification being used for initiating voting for enabling the group joining permission. The terminal sets the chat group to the public state when it is determined, based on a voting result transmitted by the social account corresponding to the virtual object in the chat group, that there is support for enabling the group joining permission, and switches the permission release control to the permission setting control.

In an exemplary example, it is only required that a quantity of social accounts supporting enabling of the group joining permission is greater than a quantity of social accounts opposing enabling of the group joining permission. Therefore, if the terminal determines, based on the voting result transmitted by the social account corresponding to the virtual object in the chat group, that the quantity of social accounts supporting enabling of the group joining permission is greater than the quantity of social accounts opposing enabling of the group joining permission, the terminal sets the chat group to the public state.

In the foregoing embodiment, when the chat group enters the private chat state, the permission setting control is switched to the permission release control, so that the social account in the chat group may be provided with an opportunity to set the chat group to the public state again, optimizing the process of setting the status of the chat group.

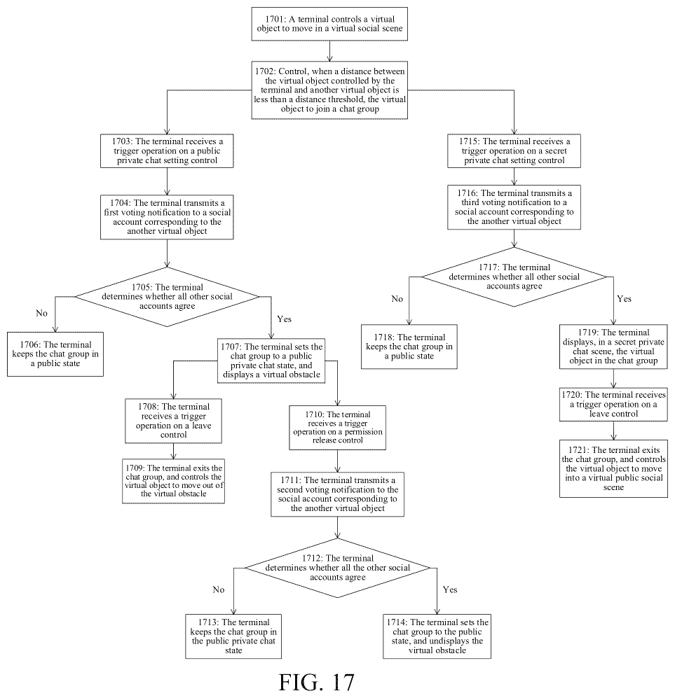

With reference to the foregoing embodiments, FIG. 17 is a flowchart of a virtual social scene display method according to an exemplary embodiment of this application. The method includes the following operations:

Operation 1701: A terminal controls a virtual object to move in a virtual social scene.

In the virtual social scene, a social account corresponding to each virtual object may trigger a move control, to control the virtual object to move in the virtual social scene, or perform a slide operation or a tap operation on a terminal, to control the virtual object to move in the virtual social scene.

Operation 1702: Control, when a distance between the virtual object controlled by the terminal and another virtual object is less than a distance threshold, the virtual object to join a chat group.

In an exemplary example, a distance between virtual objects is determined by obtaining location coordinates of each virtual object in the virtual social scene. Therefore, when a distance between at least two virtual objects is less than the distance threshold, and the at least two virtual objects do not belong to a chat group in a private chat state, the terminal controls the at least two virtual objects to join a same chat group, and the chat group is in a public state.

Operation 1703: The terminal receives a trigger operation on a public private chat setting control.

The terminal receives a trigger operation of a user on the public private chat setting control, that is, a trigger operation of a social account corresponding to the virtual object in the chat group on the public private chat setting control.

Operation 1704: The terminal transmits a first voting notification to a social account corresponding to the another virtual object.

The terminal transmits the first voting notification to the social account corresponding to the another virtual object in the chat group, and the social account corresponding to the another virtual object votes for whether to disable a group joining permission and enter a public private chat state.

Operation 1705: The terminal determines whether all other social accounts agree.

The terminal determines, based on a received voting result, whether all social accounts corresponding to the virtual objects in the chat group agree to disable the group joining permission and enter the public private chat state, and performs operation 1707 if each social account agrees to disable the group joining permission, or performs operation 1706 if at least one social account does not agree to disable the group joining permission.

Operation 1706: The terminal keeps the chat group in the public state.

When at least one social account does not agree to disable the group joining permission, the terminal keeps the chat group in the public state.

Operation 1707: The terminal sets the chat group to the public private chat state, and displays a virtual obstacle.

When each social account agrees to disable the group joining permission, the terminal sets the chat group to the public private chat state, and displays the virtual obstacle around the virtual object in the chat group.

Operation 1708: The terminal receives a trigger operation on a leave control.

The terminal receives a trigger operation of the user on the leave control in a chat interface, that is, a trigger operation of the social account corresponding to the virtual object in the chat group on the leave control in the chat interface.

Operation 1709: The terminal exits the chat group, and controls the virtual object to move out of the virtual obstacle.

When receiving the trigger operation on the leave control, the terminal controls the virtual object to exit the chat group, and moves the virtual object out of the virtual obstacle.

Operation 1710: The terminal receives a trigger operation on a permission release control.

The terminal receives a trigger operation of the user on the permission release control, that is, a trigger operation of the social account corresponding to the virtual object in the chat group on the permission release control in the chat interface.

Operation 1711: The terminal transmits a second voting notification to the social account corresponding to the another virtual object.

The terminal transmits the second voting notification to the social account corresponding to the another virtual object in the chat group, and the social account corresponding to the another virtual object votes for whether to enable the group joining permission.

Operation 1712: The terminal determines whether all the other social accounts agree.

The terminal determines, based on a received voting result, whether all the social accounts corresponding to the virtual objects in the chat group agree to enable the group joining permission, and performs operation 1714 if each social account agrees to enable the group joining permission, or performs operation 1713 if at least one social account does not agree to enable the group joining permission.

Operation 1713: The terminal keeps the chat group in the public private chat state.

When at least one social account does not agree to enable the group joining permission, the terminal keeps the chat group in the public private chat state.

Operation 1714: The terminal sets the chat group to the public state, and undisplays the virtual obstacle.

When each social account agrees to enable the group joining permission, the terminal sets the chat group to the public state, and undisplays the virtual obstacle.

Operation 1715: The terminal receives a trigger operation on a secret private chat setting control.

The terminal receives a trigger operation of a user on the secret private chat setting control in a chat interface, that is, a trigger operation of a social account corresponding to the virtual object in the chat group on the secret private chat setting control.

Operation 1716: The terminal transmits a third voting notification to a social account corresponding to the another virtual object.

The terminal transmits the third voting notification to the social account corresponding to the another virtual object in the chat group, and the social account corresponding to the another virtual object votes for whether to disable a group joining permission and enter a secret private chat state.

Operation 1717: The terminal determines whether all other social accounts agree.

The terminal determines, based on a received voting result, whether all social accounts corresponding to the virtual objects in the chat group agree to disable the group joining permission and enter the secret private chat state, and performs operation 1719 if each social account agrees to disable the group joining permission, or performs operation 1718 if at least one social account does not agree to disable the group joining permission.

Operation 1718: The terminal keeps the chat group in the public state.

When at least one social account does not agree to disable the group joining permission, the terminal keeps the chat group in the public state.

Operation 1719: The terminal displays, in a secret private chat scene, the virtual object in the chat group.

When each social account agrees to disable the group joining permission, the terminal sets the chat group to the secret private chat state, and displays, in the secret private chat scene, the virtual object in the chat group.

Operation 1720: The terminal receives a trigger operation on a leave control.

The terminal receives a trigger operation of the user on the leave control in the chat interface, that is, a trigger operation of the social account corresponding to the virtual object in the chat group on the leave control in the chat interface.

Operation 1721: The terminal exits the chat group, and controls the virtual object to move into the virtual social scene.

When receiving the trigger operation on the leave control, the terminal controls the virtual object to exit the chat group, and controls the virtual object to move into the virtual social scene.

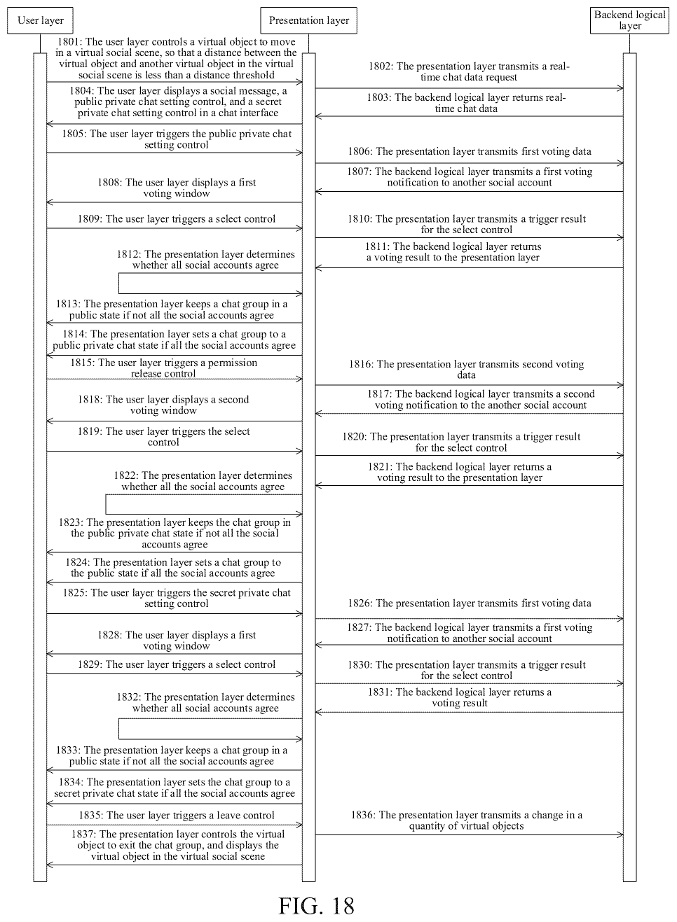

FIG. 18 is a sequence diagram of interaction between a user layer, a presentation layer, and a backend logical layer according to an exemplary embodiment of this application. In some embodiments, the user layer and the presentation layer are located in a terminal, and the backend logical layer is located in a server. An interaction process includes the following operations:

Operation 1801: The user layer controls a virtual object to move in a virtual social scene, so that a distance between the virtual object and another virtual object in the virtual social scene is less than a distance threshold.

A user triggers a move control on the terminal, to control the virtual object to move in the virtual social scene, or performs a slide operation or a tap operation, to control the virtual object to move in the virtual social scene. The virtual object is controlled to join a chat group when the distance between the virtual object and the another virtual object is less than the distance threshold.

Operation 1802: The presentation layer transmits a real-time chat data request.

The terminal transmits the real-time chat data request to the server, to obtain a social message transmitted by a social account corresponding to the another virtual object in the same chat group.

Operation 1803: The backend logical layer returns real-time chat data.

The server returns the real-time chat data to the terminal.

Operation 1804: The user layer displays the social message, a public private chat setting control, and a secret private chat setting control in a chat interface.

The terminal displays the social message in the chat interface, and displays the public private chat setting control and the secret private chat setting control.

Operation 1805: The user layer triggers the public private chat setting control.

The user triggers the public private chat setting control in the chat interface.

Operation 1806: The presentation layer transmits first voting data.

After receiving a trigger operation of the user on the public private chat setting control in the chat interface, the terminal transmits the first voting data to the server, to initiate voting on whether to enter a public private chat state and disable a group joining permission.

Operation 1807: The backend logical layer transmits a first voting notification to another social account.

The server transmits the first voting notification to a social account corresponding to the another virtual object.

Operation 1808: The user layer displays a first voting window.

A terminal corresponding to the another virtual object displays the first voting window in a chat interface.

Operation 1809: The user layer triggers a select control.

That a user corresponding to the another virtual object triggers the select control in the first voting window may be triggering an agree control or triggering a reject control.

Operation 1810: The presentation layer transmits a trigger result for the select control.

The terminal corresponding to the another virtual object transmits, to the server, a voting result corresponding to the social account for login.

Operation 1811: The backend logical layer returns the voting result to the presentation layer.

The server transmits the voting result to a terminal corresponding to each virtual object.

Operation 1812: The presentation layer determines whether all social accounts agree.

The terminal determines, based on the voting result, whether all social accounts corresponding to the virtual objects in the chat group agree to disable the group joining permission and enter the public private chat state.

Operation 1813: The presentation layer keeps the chat group in a public state if not all the social accounts agree.

When at least one social account does not agree, the terminal keeps the chat group in the public state.

Operation 1814: The presentation layer sets the chat group to a public private chat state if all the social accounts agree.

When all the social accounts agree, the terminal sets the chat group to the public private chat state, displays a virtual obstacle around the virtual object in the chat group, and switches the public private chat setting control to a permission release control.

Operation 1815: The user layer triggers the permission release control.

The user of the terminal triggers the permission release control in the chat interface.

Operation 1816: The presentation layer transmits second voting data.

After receiving a trigger operation of the user on the permission release control in the chat interface, the terminal transmits the second voting data to the server, to initiate voting on whether to return to the public state and enable the group joining permission.

Operation 1817: The backend logical layer transmits a second voting notification to the another social account.

The server transmits the second voting notification to the social account corresponding to the another virtual object.

Operation 1818: The user layer displays a second voting window.

The terminal corresponding to the another virtual object displays the second voting window in the chat interface.

Operation 1819: The user layer triggers the select control.

That the user corresponding to the another virtual object triggers the select control in the second voting window may be triggering the agree control or triggering the reject control.

Operation 1820: The presentation layer transmits a trigger result for the select control.

The terminal corresponding to the another virtual object transmits, to the server, a voting result corresponding to each social account.

Operation 1821: The backend logical layer returns the voting result to the presentation layer.

The server transmits the voting result to the terminal corresponding to each virtual object.

Operation 1822: The presentation layer determines whether all the social accounts agree.

The terminal determines, based on the voting result, whether all the social accounts corresponding to the virtual objects in the chat group agree to enable the group joining permission and return to the public state.

Operation 1823: The presentation layer keeps the chat group in the public private chat state if not all the social accounts agree.

When at least one social account does not agree, the terminal keeps the chat group in the public private chat state.

Operation 1824: The presentation layer sets the chat group to the public state if all the social accounts agree.

When all the social accounts agree, the terminal sets the chat group to the public state, undisplays the virtual obstacle around the virtual object in the chat group, and switches the permission release control to the public private chat setting control.

Operation 1825: The user layer triggers the secret private chat setting control.

The user of the terminal triggers the secret private chat setting control in the chat interface.

Operation 1826: The presentation layer transmits first voting data.

After receiving a trigger operation of the user on the public private chat setting control in the chat interface, the terminal transmits the first voting data to the server, to initiate voting on whether to enter a secret private chat state and disable a group joining permission.

Operation 1827: The backend logical layer transmits a first voting notification to another social account.

The server transmits the first voting notification to a social account corresponding to the another virtual object.

Operation 1828: The user layer displays a first voting window.

A terminal corresponding to the another virtual object displays the first voting window in a chat interface.

Operation 1829: The user layer triggers a select control.

That a user corresponding to the another virtual object triggers the select control in the first voting window may be triggering an agree control or triggering a reject control.

Operation 1830: The presentation layer transmits a trigger result for the select control.

The terminal corresponding to the another virtual object transmits, to the server, a voting result corresponding to each social account.

Operation 1831: The backend logical layer returns the voting result.

The server transmits the voting result to a terminal corresponding to each virtual object.

Operation 1832: The presentation layer determines whether all social accounts agree.

The terminal determines, based on the voting result, whether all social accounts corresponding to the virtual objects in the chat group agree to disable the group joining permission and enter the secret private chat state.

Operation 1833: The presentation layer keeps the chat group in a public state if not all the social accounts agree.

When at least one social account does not agree, the terminal keeps the chat group in the public state.

Operation 1834: The presentation layer sets the chat group in the secret private chat state if all the social accounts agree.

When all the social accounts agree, the terminal sets the chat group to the secret private chat state, displays, in a secret private chat scene, the virtual object in the chat group, and displays a leave control.

Operation 1835: The user layer triggers the leave control.

The user of the terminal triggers the leave control in the chat interface.

Operation 1836: The presentation layer transmits a change in a quantity of virtual objects.

The terminal transmits the change in the quantity of virtual objects in the chat group to the server.

Operation 1837: The presentation layer controls the virtual object to exit the chat group, and displays the virtual object in the virtual social scene.

The terminal controls the virtual object to exit the chat group, and displays the virtual object in the virtual social scene.

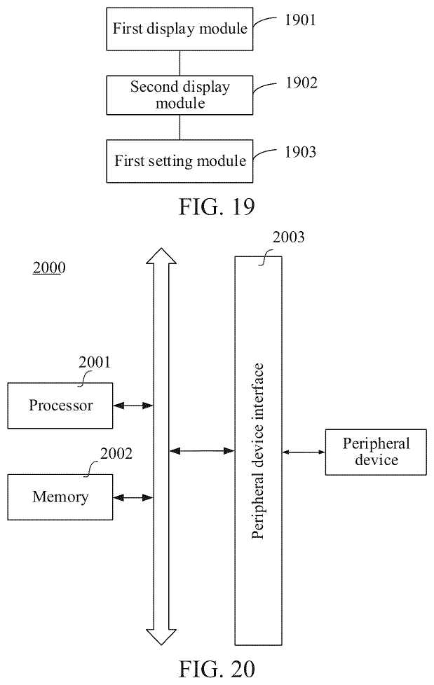

FIG. 19 is a block diagram of a structure of a virtual social scene display apparatus according to an exemplary embodiment of this application. The apparatus may include the following structures:
a first display module 1901, configured to display a virtual object in a virtual social scene, the virtual social scene being a virtual scene in which the virtual object performs social interaction, and different virtual objects corresponding to different social accounts;
a second display module 1902, configured to display a permission setting control in a chat interface when at least two virtual objects belong to a same chat group and the chat group is in a public state, a distance between the virtual objects in the chat group being less than a distance threshold, the chat group in the public state allowing another virtual object to join, and the permission setting control being used for setting a group joining permission for the chat group; and
a first setting module 1903, configured to set the chat group to a private chat state in response to a trigger operation on the permission setting control, the chat group in the private chat state not allowing the another virtual object to join.

In some embodiments, the first setting module 1903 is configured to:
transmit, in response to the trigger operation on the permission setting control, a first voting notification to a social account corresponding to the virtual object in the chat group, the first voting notification being used for initiating voting for disabling the group joining permission; and
set the chat group to the private chat state when it is determined, based on a voting result transmitted by the social account corresponding to the virtual object in the chat group, that there is support for disabling the group joining permission.

In some embodiments, the first setting module 1903 is configured to:
set the chat group to the private chat state when a first voting result transmitted by a social account corresponding to each virtual object in the chat group is received, the first voting result representing support for disabling the group joining permission.

In some embodiments, the apparatus further includes:
a third display module, configured to display a first prompt message when at least one second voting result transmitted by the social account corresponding to the virtual object in the chat group is received, the second voting result representing opposition to disabling of the group joining permission, and the first prompt message being used for indicating that there is a social account opposing disabling of the group joining permission;
a state keeping module, configured to keep the chat group in the public state; and
a control state setting module, configured to set the permission setting control to a non-triggerable state.

The control state setting module is further configured to set the permission setting control to a triggerable state when duration of the non-triggerable state reaches a first duration threshold.

In some embodiments, the apparatus further includes:
a fourth display module, configured to display, in the private chat state, a leave control in the chat interface;
a first control module, configured to control, in response to a trigger operation on the leave control, the virtual object in the chat group to exit the chat group; and
a group disbanding module, configured to disband the chat group when a quantity of virtual objects in the chat group is less than a quantity threshold.

In some embodiments, the apparatus further includes:
a switching module, configured to switch the permission setting control to a permission release control when the chat group is switched from the public state to the private chat state, the permission release control being used for releasing the group joining permission;
a transmission module, configured to transmit, in response to a trigger operation on the permission release control, a second voting notification to a social account corresponding to the virtual object in the chat group, the second voting notification being used for initiating voting for enabling the group joining permission; and
a group state setting module, configured to set the chat group to the public state when it is determined, based on a voting result transmitted by the social account corresponding to the virtual object in the chat group, that there is support for enabling the group joining permission.

The switching module is further configured to switch the permission release control to the permission setting control.

In some embodiments, the group state setting module is configured to set the chat group to the public state when a third voting result transmitted by a social account corresponding to each virtual object in the chat group is received, the third voting result representing support for enabling the group joining permission.

In some embodiments, the apparatus further includes:
a fifth display module, configured to display a second prompt message when at least one fourth voting result transmitted by the social account corresponding to the virtual object in the chat group is received, the fourth voting result representing opposition to enabling of the group joining permission, and the second prompt message being used for indicating that there is a social account opposing enabling of the group joining permission.

The state keeping module is further configured to keep the chat group in the private chat state.

The control state setting module is further configured to set the permission release control to the non-triggerable state.

The control state setting module is further configured to set the permission release control to the triggerable state when duration of the non-triggerable state reaches a second duration threshold.

In some embodiments, the permission setting control includes a public private chat setting control and a secret private chat setting control.

The first setting module 1903 is configured to:
set the chat group to a public private chat state in response to a trigger operation on the public private chat setting control, the virtual object in the chat group in the public private chat state being visible to another virtual object outside the chat group, and display a virtual obstacle around the virtual object in the chat group; or
set the chat group to a secret private chat state in response to a trigger operation on the secret private chat setting control, and display, in a secret private chat scene, the virtual object in the chat group, the secret private chat scene being independent of the virtual social scene, and the virtual object in the secret private chat scene being invisible to the virtual object in the virtual social scene.

In some embodiments, the apparatus further includes:
a marking module, configured to mark the virtual object in the chat group when the chat group is switched from the public state to the public private chat state.

The marking module is further configured to unmark the virtual object in the chat group when the chat group is switched from the public private chat state to the public state.

In some embodiments, the second display module 1902 is configured to:
control, when the distance between the at least two virtual objects is less than the distance threshold and the at least two virtual objects are not marked, the at least two virtual objects to join the chat group in the public state; and
display the permission setting control in the chat interface.

In some embodiments, the second display module 1902 is further configured to:
control, when the distance between the at least two virtual objects is less than the distance threshold and a connection line between the at least two virtual objects does not pass through the virtual obstacle, the at least two virtual objects to join the chat group in the public state; and
display the permission setting control in the chat interface.

In some embodiments, the apparatus further includes:
a second control module, configured to control, when the chat group is in the public private chat state, the virtual object in the chat group to move toward a boundary of the virtual obstacle; and
a third control module, configured to control, when the virtual object reaches the boundary of the virtual obstacle and continues to move outward, the virtual object to jump out of the virtual obstacle and exit the chat group.

In some embodiments, the apparatus further includes:
a sixth display module, configured to display a third prompt message when the chat group is in the public private chat state and a group joining request transmitted by the another virtual object outside the chat group is received, the third prompt message being used for indicating that there is the another virtual object applying to join the chat group; and
a fourth control module, configured to control, when a social account corresponding to each virtual object in the chat group accepts the group joining request, the another virtual object to join the chat group.

In summary, in this embodiment of this application, a virtual social scene in which a virtual object corresponding to a social account performs social interaction is constructed. In the virtual social scene, the social account may control the virtual object to move to make a distance between virtual objects is less than a distance threshold, to create a chat group in a public state between at least two virtual objects whose distance is less than the distance threshold, where the chat group in the public state allows another virtual object to join. A permission setting control is displayed in a chat interface. The permission setting control is used for setting a group joining permission for the chat group. Further, the chat group may be set to a private chat state in response to a trigger operation on the permission setting control, where the chat group in the private chat state does not allow the another virtual object to join. According to the solution provided in this embodiment of this application, a chat permission setting opportunity may be provided in a virtual social scene for a chat group that is in a public state but has a private chat requirement, so that a social account in the chat group may set permission to join the chat group by using the permission setting control, optimizing chat group setting in the virtual social scene, enriching social types in the virtual social scene, and providing privacy protection for social interaction between social accounts corresponding to virtual objects in the chat group.

Division of the apparatus provided in the foregoing embodiment into the functional modules is used merely as an example for description. In actual applications, depending on a requirement, the functions may be allocated to different functional modules for implementation, that is, an internal structure of the apparatus is divided into different functional modules to implement all or some of the functions described above. In addition, the apparatus provided in the foregoing embodiment falls within a same concept as the method embodiment. For details of a specific implementation process of the apparatus, refer to the method embodiment. Details are not described herein again.

FIG. 20 is a block diagram of a structure of a terminal 2000 according to an exemplary embodiment of this application. The terminal 2000 may be a portable mobile terminal, for example, a smartphone, a tablet computer, a MP3 player, or a MP4 player. The terminal 2000 may also be referred to as user equipment, a portable terminal, or another name.

Generally, the terminal 2000 includes a processor 2001 and a memory 2002.

The processor 2001 may include one or more processing cores, for example, a 4-core processor or an 8-core processor. The processor 2001 may be implemented by using at least one of the following hardware forms: a digital signal processor (DSP), a field programmable gate array (FPGA), and a programmable logic array (PLA). Alternatively, the processor 2001 may include a main processor and a co-processor. The main processor is a processor configured to process data in an awake state, and is also referred to as a central processing unit (CPU). The co-processor is a low-power-consumption processor configured to process data in a standby state. In some embodiments, the processor 2001 may be integrated with a graphics processing unit (GPU), and the GPU is responsible for rendering and drawing content required to be displayed on a display screen. In some embodiments, the processor 2001 may include an artificial intelligence (AI) processor, and the AI processor is configured to process a machine learning related computing operation.

The memory 2002 may include one or more computer-readable storage media. The computer-readable storage medium may be tangible and non-transitory. The memory 2002 may further include a high-speed random access memory and a nonvolatile memory, for example, one or more disk storage devices or flash storage devices. In some embodiments, the non-transitory computer-readable storage medium in the memory 2002 is configured to store at least one instruction, and the at least one instruction is used for being executed by the processor 2001 to implement the virtual social scene display method provided in the embodiments of this application.

In some embodiments, the terminal 2000 may include a peripheral device interface 2003 and at least one peripheral device.

The peripheral device interface 2003 may be configured to connect at least one peripheral device related to input/output (I/O) to the processor 2001 and the memory 2002. In some embodiments, the processor 2001, the memory 2002, and the peripheral device interface 2003 are integrated on a same chip or circuit board. In some other embodiments, any one or two of the processor 2001, the memory 2002, and the peripheral device interface 2003 may be implemented on an independent chip or circuit board. This is not limited in this embodiment.

A person skilled in the art may understand that the structure shown in FIG. 20 constitutes no limitation on the terminal 2000, and the terminal may include more or fewer components than those shown in the figure, or some components may be combined, or a different component deployment may be used.

An embodiment of this application further provides a non-transitory computer-readable storage medium, storing at least one program, the at least one program being loaded and executed by a processor to implement the virtual social scene display method in the foregoing embodiments.

According to an aspect of this application, a computer program product is provided. The computer program product includes computer instructions. The computer instructions are stored in a computer-readable storage medium. A processor of a terminal reads the computer instructions from the computer-readable storage medium. The processor executes the computer instructions, so that the terminal implements the virtual social scene display method in the foregoing embodiments.

A person skilled in the art should be aware that in the foregoing one or more examples, the functions described in the embodiments of this application may be implemented by hardware, software, firmware, or any combination thereof. When implemented by using software, the functions can be stored in a computer-readable storage medium or can be used as one or more instructions or code in a computer-readable storage medium for transmission. The computer-readable storage medium includes a computer storage medium and a communication medium, where the communication medium includes any medium that enables a computer program to be transmitted from one place to another. The storage medium may be any available medium accessible to a general-purpose or dedicated computer.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for displaying a virtual social scene, the method comprising:
displaying, by a terminal, a virtual social scene in which a plurality of virtual objects corresponding to different social accounts perform social interactions with one another;
displaying, by the terminal, a permission setting control in a chat interface when at least two virtual objects belong to a same chat group and the chat group is in a public state, a distance between the at least two virtual objects in the chat group being less than a distance threshold; and
setting, by the terminal, the chat group to a private chat state in response to a trigger operation on the permission setting control.

2. The method according to claim 1, wherein the setting, by the terminal, the chat group to a private chat state in response to a trigger operation on the permission setting control comprises:
transmitting, by the terminal and in response to the trigger operation on the permission setting control, a first voting notification to a social account corresponding to a virtual object in the chat group; and
setting, by the terminal, the chat group to the private chat state for disabling group joining permission for the chat group based on a voting result transmitted by the social account corresponding to the virtual object in the chat group.

3. The method according to claim 2, wherein the setting, by the terminal, the chat group to the private chat state for disabling group joining permission for the chat group based on a voting result transmitted by the social account corresponding to the virtual object in the chat group comprises:
setting, by the terminal, the chat group to the private chat state when a first voting result transmitted by a social account corresponding to each virtual object in the chat group is received, the first voting result representing support for disabling the group joining permission.

4. The method according to claim 1, further comprising:
displaying, by the terminal in the private chat state, a leave control in the chat interface;
controlling, by the terminal and in response to a trigger operation on the leave control, the virtual object in the chat group to exit the chat group; and
disbanding, by the terminal, the chat group when a quantity of virtual objects in the chat group is less than a quantity threshold.

5. The method according to claim 1, further comprising:
switching, by the terminal, the permission setting control to a permission release control when the chat group is switched from the public state to the private chat state, the permission release control being used for releasing the group joining permission;
transmitting, by the terminal and in response to a trigger operation on the permission release control, a second voting notification to a social account corresponding to the virtual object in the chat group; and
setting, by the terminal, the chat group to the public state for enabling the group joining permission based on a voting result transmitted by the social account corresponding to the virtual object in the chat group; and
switching, by the terminal, from the permission release control to the permission setting control.

6. The method according to claim 1, wherein the permission setting control comprises a public private chat setting control and a secret private chat setting control; and
the setting, by the terminal, the chat group to a private chat state in response to a trigger operation on the permission setting control comprises:
setting, by the terminal, the chat group to a public private chat state in response to a trigger operation on the public private chat setting control, the virtual object in the chat group in the public private chat state being visible to another virtual object outside the chat group, and displaying a virtual obstacle around the virtual object in the chat group; or
setting, by the terminal, the chat group to a secret private chat state in response to a trigger operation on the secret private chat setting control, and displaying, in a secret private chat scene, the virtual object in the chat group, the secret private chat scene being independent of the virtual social scene, and the virtual object in the secret private chat scene being invisible to the virtual object in the virtual social scene.

7. The method according to claim 6, further comprising:
marking, by the terminal, the virtual object in the chat group when the chat group is switched from the public state to the public private chat state; and
unmarking, by the terminal, the virtual object in the chat group when the chat group is switched from the public private chat state to the public state.

8. The method according to claim 6, further comprising:
controlling, by the terminal when the chat group is in the public private chat state, the virtual object in the chat group to move toward a boundary of the virtual obstacle; and
controlling, by the terminal when the virtual object reaches the boundary of the virtual obstacle and continues to move outward, the virtual object to jump out of the virtual obstacle and exit the chat group.

9. The method according to claim 6, further comprising:
displaying, by the terminal, a prompt message when the chat group is in the public private chat state and a group joining request transmitted by another virtual object outside the chat group is received; and
controlling, by the terminal, the another virtual object to join the chat group when a social account corresponding to each virtual object in the chat group agrees to the group joining request.

10. The method according to claim 1, wherein the displaying, by the terminal, a permission setting control in a chat interface when at least two virtual objects belong to a same chat group and the chat group is in a public state comprises:
controlling, by the terminal when the distance between the at least two virtual objects is less than the distance threshold and a connection line between the at least two virtual objects does not pass through the virtual obstacle, the at least two virtual objects to join the chat group in the public state; and
displaying, by the terminal, the permission setting control in the chat interface.

11. A terminal, comprising a processor and a memory, the memory storing at least one instruction, and the at least one instruction, when executed by the processor, causing the terminal to implement a method for displaying a virtual social scene including:
displaying, by the terminal, a virtual social scene in which a plurality of virtual objects corresponding to different social accounts perform social interactions with one another;
displaying, by the terminal, a permission setting control in a chat interface when at least two virtual objects belong to a same chat group and the chat group is in a public state, a distance between the at least two virtual objects in the chat group being less than a distance threshold; and
setting, by the terminal, the chat group to a private chat state in response to a trigger operation on the permission setting control.

12. The terminal according to claim 11, wherein the setting, by the terminal, the chat group to a private chat state in response to a trigger operation on the permission setting control comprises:
transmitting, by the terminal and in response to the trigger operation on the permission setting control, a first voting notification to a social account corresponding to a virtual object in the chat group; and
setting, by the terminal, the chat group to the private chat state for disabling group joining permission for the chat group based on a voting result transmitted by the social account corresponding to the virtual object in the chat group.

13. The terminal according to claim 11, wherein the method further comprises:
displaying, by the terminal in the private chat state, a leave control in the chat interface;
controlling, by the terminal and in response to a trigger operation on the leave control, the virtual object in the chat group to exit the chat group; and
disbanding, by the terminal, the chat group when a quantity of virtual objects in the chat group is less than a quantity threshold.

14. The terminal according to claim 11, wherein the method further comprises:
switching, by the terminal, the permission setting control to a permission release control when the chat group is switched from the public state to the private chat state, the permission release control being used for releasing the group joining permission;
transmitting, by the terminal and in response to a trigger operation on the permission release control, a second voting notification to a social account corresponding to the virtual object in the chat group; and
setting, by the terminal, the chat group to the public state for enabling the group joining permission based on a voting result transmitted by the social account corresponding to the virtual object in the chat group; and
switching, by the terminal, from the permission release control to the permission setting control.

15. The terminal according to claim 11, wherein the permission setting control comprises a public private chat setting control and a secret private chat setting control; and
the setting, by the terminal, the chat group to a private chat state in response to a trigger operation on the permission setting control comprises:
setting, by the terminal, the chat group to a public private chat state in response to a trigger operation on the public private chat setting control, the virtual object in the chat group in the public private chat state being visible to another virtual object outside the chat group, and displaying a virtual obstacle around the virtual object in the chat group; or
setting, by the terminal, the chat group to a secret private chat state in response to a trigger operation on the secret private chat setting control, and displaying, in a secret private chat scene, the virtual object in the chat group, the secret private chat scene being independent of the virtual social scene, and the virtual object in the secret private chat scene being invisible to the virtual object in the virtual social scene.

16. The terminal according to claim 15, wherein the method further comprises:
marking, by the terminal, the virtual object in the chat group when the chat group is switched from the public state to the public private chat state; and
unmarking, by the terminal, the virtual object in the chat group when the chat group is switched from the public private chat state to the public state.

17. The terminal according to claim 15, wherein the method further comprises:
controlling, by the terminal when the chat group is in the public private chat state, the virtual object in the chat group to move toward a boundary of the virtual obstacle; and
controlling, by the terminal when the virtual object reaches the boundary of the virtual obstacle and continues to move outward, the virtual object to jump out of the virtual obstacle and exit the chat group.

18. The terminal according to claim 15, wherein the method further comprises:
displaying, by the terminal, a prompt message when the chat group is in the public private chat state and a group joining request transmitted by another virtual object outside the chat group is received; and
controlling, by the terminal, the another virtual object to join the chat group when a social account corresponding to each virtual object in the chat group agrees to the group joining request.

19. The terminal according to claim 11, wherein the displaying, by the terminal, a permission setting control in a chat interface when at least two virtual objects belong to a same chat group and the chat group is in a public state comprises:
controlling, by the terminal when the distance between the at least two virtual objects is less than the distance threshold and a connection line between the at least two virtual objects does not pass through the virtual obstacle, the at least two virtual objects to join the chat group in the public state; and
displaying, by the terminal, the permission setting control in the chat interface.

20. A non-transitory computer-readable storage medium, having at least one instruction stored therein, the at least one instruction, when executed by a processor of a terminal, causing the terminal to implement a method for displaying a virtual social scene including:
displaying, by the terminal, a virtual social scene in which a plurality of virtual objects corresponding to different social accounts perform social interactions with one another;
displaying, by the terminal, a permission setting control in a chat interface when at least two virtual objects belong to a same chat group and the chat group is in a public state, a distance between the at least two virtual objects in the chat group being less than a distance threshold; and
setting, by the terminal, the chat group to a private chat state in response to a trigger operation on the permission setting control.
